(19) United States
(12) Patent Application Publication
(10) Pub. No.: US 2011/0007796 A1
(43) Pub. Date: Jan. 13, 2011

(54) MOVING PICTURE COMPRESSION TRANSMISSION APPARATUS, MOVING PICTURE COMPRESSION TRANSMISSION PROGRAM STORAGE MEDIUM AND MOVING PICTURE COMPRESSION TRANSMISSION METHOD

(75) Inventor: Yukio SUGITA, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: FUJIFILM CORPORATION, TOKYO (JP)

(21) Appl. No.: 12/797,954

(22) Filed: Jun. 10, 2010

(30) Foreign Application Priority Data
Jul. 7, 2009 (JP) 2009-161065

(51) Int. Cl. H04N 11/04

(52) U.S. Cl. 375/240.01; 375/E07.026

(57) ABSTRACT

A moving picture compression transmission apparatus, a computer-readable storage medium storing a moving picture compression transmission program, and a moving picture compression transmission method, which are tolerant of data loss in transfer are provided. The moving picture compression transmission apparatus includes: a thinning processing section that thins out numeric values from consecutive numeric values of each image data forming to-be-compressed data representing a moving picture in consecutive image data expressing a still image in consecutive numeric value, so as to create, for each image data, first data made of consecutive thinned-out numeric values and second data made of consecutive remaining numeric values; a first compression section that applies reversible compression processing to the first data; a second compression section that applies irreversible compression processing to the second data; and a data transmission section that transmits first compressed data and second compressed data, for each image data forming the to-be-compressed data.

### TECHNICAL FIELD

The present invention is directed to a moving picture compression transmission apparatus, a computer-readable storage medium storing a moving picture compression transmission program, and a moving picture compression transmission method, which apply compression processing to data representing a moving picture to be transmitted.

### BACKGROUND ART

With the advancement of digital technology, various techniques which express a moving picture in digital data and perform shooting, recording, reproducing and so on are widely used.

Moving picture data representing such a moving picture generally has a large amount of data, and in many cases, there is a need for transmitting data in real time, for example, in parallel with shooting or reproducing the moving picture. For this reason, there is a demand for compressing data to be transmitted by an appropriate compression technique, and some types of moving picture compression transmission techniques are widely used.

As typical techniques of moving picture compression transmission, there are known a method that applies still image compression on each frame for consecutive still images (frame) included in a moving picture to be transmitted, and a method that transmits differential information between frames.

Patent Literature

Patent Literature 1: Japanese Laid-open Patent Application No. 2004-72683

Patent Literature 2: Japanese Laid-open Patent Application No. H11-275523

However, while transmitting a moving picture, there is a case in which a part of data is lost due to a temporary failure of communications or the like. In such a case, inmost of the conventional still image compression methods, especially when a compression ratio is high, it is not possible to reproduce an entire still image even if the loss is partial. Further, in the conventional differential information methods, the loss of data affects plural frames that follow.

The present invention is made in view of the above circumstances, and it is an object according to aspects of the present invention to provide a moving picture compression transmission apparatus, a computer-readable storage medium storing a moving picture compression transmission program, and a moving picture compression transmission method that are tolerant of data loss during transfer.

### DISCLOSURE OF INVENTION

According to a first aspect of the invention, a moving picture compression transmission apparatus includes:

a thinning processing section that thins out numeric values from a series of numeric values of each image data forming to-be-compressed data representing a moving picture in a series of image data expressing a still image in a series of numeric values, so as to create, for each image data, first data made of a series of thinned-out numeric values and second data made of a series of remaining numeric values;

a first compression section that applies reversible compression processing to the first data;

a second compression section that applies irreversible compression processing to the second data; and

a data transmission section that transmits first compressed data obtained by the first compression section and second compressed data obtained by the second compression section, for each image data forming the to-be-compressed data.

Here, it is preferable that transmission of data by the transmission section is performed in the order of the first compressed data, and followed by the second compressed data.

In the moving picture compression transmission apparatus according to the first aspect of the invention, it is preferable that, when the thinning processing section thins out numeric values, the thinning processing section changes positions of the numeric values to be thinned out on the still image, for pieces of the image data which are next to each other with respect to time.

In the moving picture compression transmission apparatus according to the first aspect of the invention, it is preferable that the first compression section includes a difference generation section which obtains differences between numeric values being next to each other for a series of numeric values included in the first data, so as to generate differential data made of a series of numeric values representing the differences, and the first compression section applies the reversible compression processing to the differential data generated by the difference generation section.

In the moving picture compression transmission apparatus according to the first aspect of the invention, it is further preferable that the first compression section includes a difference generation section which obtains two-dimensional differences based on multiple numeric values adjacent to a numeric value in multiple directions on the still image, for the numeric value included in the first data, so as to generate differential data made of a series of numeric values representing the differences, and the first compression section applies the reversible compression processing to the differential data generated by the difference generation section.

In the moving picture compression transmission apparatus according to the first aspect of the invention, such a mode is also preferable that the difference generation section generates, as the differential data, differential data made of a series of numeric values representing the differences in a predetermined unit bit number, and

the first compression section includes:

an offset section which offsets, by a predetermined value, each numeric value included in the differential data generated by the difference generation section;

a division section which divides each numeric value of the data which are offset by the offset section into a higher-order bit portion and a lower-order bit portion at a predetermined division bit number that is smaller than the unit bit number, so as to divide the data into higher-order data including a series of the higher-order bit portions of each numeric value and lower-order data including a series of the lower-order bit portions of each numeric value; and

a higher-order data compression section which applies the reversible compression processing to the higher-order data divided by the division section. In this preferable mode, it is still more preferable that the moving picture compression transmission apparatus further includes a lower-order data compression section which applies the reversible compression processing to the lower-order data divided by the division section.

In the moving picture compression transmission apparatus according to the first aspect of the invention, it is all the more preferable that the image data included in the to-be-compressed data is made of a series of numeric values represented in a predetermined unit bit number, and

the second compression section includes:

a determination section which determines an edge portion in the still image; and

a data conversion section which, for the numeric values included in the second data generated by the thinning processing section, outputs a predetermined code in a bit number smaller than the unit bit number when a numeric value of the numeric values is not in the edge portion determined by the determination section, and outputs a numeric value represented in a bit number smaller than or equal to the unit bit number when the numeric value is in the edge portion. In this all the more preferable mode, it is still further preferable that the data conversion section truncates a lower-order digit of a bit value of the unit bit number for expressing a numeric value in a smaller bit number.

According to a second aspect of the invention, a computer-readable storage medium stores a moving picture compression transmission program which is incorporated in an information processing apparatus and executed in the information processing apparatus, thereby constructing on the information processing apparatus:

a thinning processing section that thins out numeric values from a series of numeric values of each image data forming to-be-compressed data representing a moving picture in a series of image data expressing a still image in a series of numeric values, so as to create, for each image data, first data made of a series of thinned-out numeric values and second data made of a series of remaining numeric values;

a first compression section that applies reversible compression processing to the first data;

a second compression section that applies irreversible compression processing to the second data; and

a data transmission section that transmits first compressed data obtained by the first compression section and second compressed data obtained by the second compression section, for each image data forming the to-be-compressed data.

According to a third aspect of the invention, a moving picture compression transmission method is executed in an apparatus, including:

thinning processing of thinning out numeric values from a series of numeric values of each image data forming to-be-compressed data representing a moving picture in a series of image data expressing a still image in a series of numeric values, so as to create, for each image data, first data made of a series of thinned-out numeric values and second data made of a series of remaining numeric values;

first compression of applying reversible compression processing to the first data;

second compression of applying irreversible compression processing to the second data; and

data transmission of transmitting first compressed data obtained by the first compression and second compressed data obtained by the second compression, for each image data forming the to-be-compressed data in the order of the first compressed data followed by the second compressed data.

Incidentally, as for the moving picture compression transmission program and the moving picture compression transmission method, only basic modes are illustrated. However, this is only for the sake of avoiding redundancy, and the moving picture compression transmission program and the moving picture compression transmission method include not only the above-described basic mode, but also various types of modes corresponding to the respective modes of the above-described moving picture compression transmission apparatus.

In addition, regarding an element such as the thinning processing section that is constructed on a computer by the moving picture compression program of the present invention, one element may be constructed by one program component, one element may be constructed by plural program components, and plural elements may be constructed by one program component. Further, these elements may be constructed as an element that executes such processing by themselves, or may be constructed as an element that provides an instruction to another program or program component installed in the computer to execute the processing.

According to the moving picture compression transmission apparatus, the moving picture compression transmission program storage medium and the moving picture compression transmission method of the present invention, data is thinned out for each still image (so-called frame) included in a moving picture, then the thinned-out data is subjected to reversible compression to maintain image quality and remaining data after the thinning is subjected to irreversible compression to achieve a high compression ratio. Thereafter, the reversibly compressed data is transmitted first, and followed by the irreversibly compressed data. With this, even if a part of the data is lost in transmission, as long as the loss is in the irreversibly compressed data, it is possible to reproduce a frame with a certain level of image quality. That is, the present invention is tolerant of data loss in a transfer.

If the thinning processing section changes positions where pixels are thinned out among the frames that are adjacent to each other with respect to time, it is possible to reproduce an image with the high quality at any moment in a moving picture, by collecting reversible portions of some consecutive frames including the moment. That is, both image quality and a compression ratio are compatible in a high level.

When the first compression section generates a difference to apply reversible compression, an efficient compression may be expected despite the reversible compression, and the probability of loss generation in the course of reversibly compressing the data is reduced. Also, the image quality and the compression ratio may be compatible in a high level. In addition, when a two-dimensional difference is obtained in obtaining the difference, frequency of occurrence in which the difference is zero increases, so that the compression by reversible compression becomes more efficient.

According to the mode in which the first compression section includes the division section and the like and performs processing by dividing data into the higher-order data and the lower-order data, it is possible to apply processing suitable to each of the higher-order data and the lower-order data in each of which a distribution trend of numeric values in the data is distinguishably different, and the image quality and a compression ratio may be compatible in a further high level. Furthermore, such higher-order data and lower-order data are expected of great compression by the reversible compression whose algorithm is simple, a processing time for the compression is short.

When converting the second data, since the second compression section switches compression depending on whether or not the second data is an edge portion in an image, it is possible to achieve compression of a high degree in a non-edge portion and also to maintain the image quality by applying less compression to the edge portion. Moreover, if the data conversion section truncates the lower-order digits, computation is not required and thus conversion becomes easier.

### BRIEF DESCRIPTION OF THE DRAWINGS

FIG. 1 is a schematic block diagram illustrating an embodiment of the moving picture compression transmission apparatus of the present invention;

FIG. 2 is a schematic hardware diagram of a personal computer in which a moving picture compression transmission apparatus of the present invention is constructed;

FIG. 3 is a schematic diagram of a moving picture compression transmission program corresponding to an embodiment of the moving picture compression transmission program of the present invention;

FIG. 4 is a diagram illustrating a data structure of image data inputted into the moving picture compression transmission apparatus and a concept of thinning processing;

FIG. 5 is a diagram illustrating a change of thinning positions between frames;

FIG. 6 is a schematic diagram of a radiographic image diagnosis system;

FIG. 7 is a diagram illustrating a structure of TRUE pixel data inputted into a differential encoding section;

FIG. 8 is a diagram illustrating a data structure after the TRUE pixel data is subjected to two-dimensional differential encoding processing;

FIG. 9 is a diagram illustrating the two-dimensional differential encoding processing in the differential encoding section, by way of example;

FIGS. 10A and 10B are diagrams illustrating an example of image data;

FIGS. 11A and 11B are diagrams illustrating differential encoding and an effect of the offset for an image data.

FIG. 12 is a diagram explaining an effect of data division by a plane division section;

FIG. 13 is a diagram explaining encoding in a run-length encoding section;

FIG. 14 is a diagram illustrating an algorithm of the encoding that targets to-be-compressed numeric values in the run-length encoding section;

FIG. 15 is a diagram illustrating an example of the encoding processing according to a number of consecutive pieces in the run-length encoding section;

FIG. 16 is a diagram illustrating an example of a scanning result by a data scanning section;

FIG. 17 is a diagram illustrating an example of Huffman table;

FIG. 18 is a diagram illustrating an encoding scheme of encoding into a 4-bit code;

FIG. 19 is a diagram illustrating a structure of data included in one flame, before and after the compression; and

FIG. 20 is a diagram illustrating the concept of plane transmitted by a data transmission section.

### DETAILED DESCRIPTION OF THE INVENTION

An exemplary embodiment of the present invention will be described with reference to the accompanying drawings.

The embodiment described below is a moving picture compression transmission apparatus into which, for example, moving picture data obtained by shooting with a security camera is inputted and which subjects data compression processing to the moving picture data to be transmitted. This moving picture data represents a moving picture made up of a series in time of multiple frames, and each frame represents a still image. The moving picture data has such a data structure that image data representing a still image in each frame is in a series, and this moving picture compression transmission apparatus receives each image data sequentially and processes the image data.

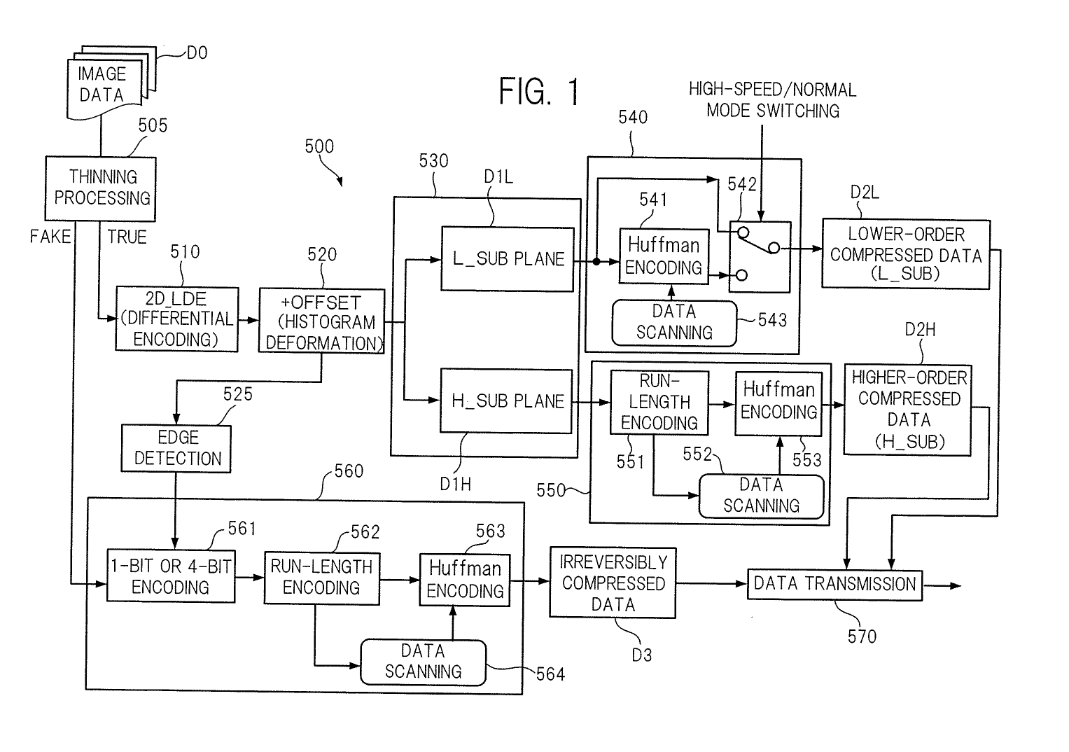

FIG. 1 is a schematic block diagram illustrating an embodiment of the moving picture compression transmission apparatus of the present invention.

A moving picture compression transmission apparatus 500 illustrated in FIG. 1 is constructed in a personal computer which is a kind of information processing apparatus; and the moving picture compression transmission apparatus 500 includes a thinning processing section 505, a differential encoding section 510, an offset section 520, an edge detection section 525, a plane division section 530, a L-plane compression section 540, a H-plane compression section 550, a FAKE pixel compression section 560, and a data transmission section 570. Although details of the sections 505 through 570 will be described later, a flow of image data in this moving picture compression transmission apparatus 500 is as follows.

An image data D0 is inputted into the thinning processing section 505 of the moving picture compression transmission apparatus 500 illustrated in FIG. 1, and TRUE pixel data corresponding to periodical pixel portions in an image are taken out from the image data. The remaining data after the thinning forms FAKE pixel data. The TRUE pixel data and the FAKE pixel data each corresponds to an example of each of the first data and the second data of the present invention. The thinning processing section 505 corresponds to an example of the thinning processing section of the present invention, and the processing in this thinning processing section 505 corresponds to an example of the thinning processing according to the present invention.

The TRUE pixel data is inputted into the differential encoding section 510 and is subjected to two-dimensional differential encoding processing, that is, for consecutive numeric values forming the inputted data, a two-dimensional difference is obtained based on plural numeric values adjacent to a numeric value in interest in plural directions respectively when viewed on the image is obtained, to generate image data made of a series of 8-bit numeric values representing the differences. This differential encoding section 510 corresponds to an example of the difference generation section of the present invention. Incidentally, as the difference generation section of the present invention, although the section may be one that obtains one-dimensional differences in a main scanning direction or a sub-scanning direction, the differential encoding section 510 to obtain a two-dimensional difference is employed in this embodiment.

The image data made up of the series of numeric values representing the differences generated in the differential encoding section 510 is inputted into the offset section 520 and offset by a predetermined value. Then, the image data is inputted into the edge detection section 525 and the plane division section 530. In the edge detection section 525, an edge portion of the image is detected based on the offset differential value, and in the plane division section 530, each 8-bit numeric value in the image data is divided into lower-order 4 bits and higher-order 4 bits, so that the image data is divided into a lower-order sub-plane D1L made up of consecutive numeric values in lower-order 4-bit and a higher-order sub-plane D1H made up of consecutive numeric values in higher-order 4-bit. The offset section 520 corresponds to an example of the offset section of the present invention, the edge detection section 525 corresponds to an example of the determination section of the present invention, and the plane division section 530 corresponds to an example of the division section of the present invention. Further, the lower-order sub-plane D1L and the higher-order sub-plane D1H each corresponds to an example of each of the lower-order data and the higher-order data of the present invention.

The lower-order sub-plane D1L and the higher-order sub-plane D1H which are divided by the plane division section 530 are inputted into the L-plane compression section 540 and the H-plane compression section 550, respectively, and subjected to the reversible compression. The L-plane compression section 540 and the H-plane compression section 550 each corresponds to an example of each of the lower-order data compression section and the higher-order data compression section, of the present invention. Further, the processing in the L-plane compression section 540 and the processing in the H-plane compression section 550 correspond to an example of the first compression step of the present invention.

The L-plane compression section 540 includes a Huffman encoding section 541, a mode switching section 542 to switch the mode to either a high-speed mode or a normal mode, and a data scanning section 543. The lower-order sub-plane D1L inputted from the plane division section 530 is inputted into both of the data scanning section 543 and the Huffman encoding section 541 of the L-plane compression section 540.

In the data scanning section 543, all the data of the lower-order sub-plane D1L is scanned and frequencies of occurrence (histogram) are determined for all numeric values occurring in the data. Here, in this embodiment, processing of obtaining the frequencies of occurrence is performed for each lower-order sub-plane D1L illustrated in FIG. 1 as a unit, and frequencies of occurrence of numeric values in the data of each lower-order sub-plane D1L are obtained.

In addition, the data scanning section 543 allocates, based on the obtained data histogram (frequencies of occurrence of a numeric value), a code with a shorter code length for a numeric value with a greater frequency of occurrence in the Huffman table. In this way, the Huffman table in which numeric values and codes are associated is updated by the data scanning section 543.

The Huffman table in which the codes are allocated to the numeric values by the data scanning section 543 is passed to the Huffman encoding section 541. Subsequently, the Huffman encoding section 541 of the L-plane compression section 540 performs encoding processing in which numeric values included in the lower-order sub-plane D1L inputted into the Huffman encoding section 541 are replaced with codes according to the passed Huffman table.

The data after Huffman-encoded in the Huffman encoding section 541 is attached with compression information including an allocation table of the numeric values and codes allocated by the data scanning section 543 and forms a lower-order compressed data D2L in which the lower-order sub-plane D1L is compressed.

The mode switching section 542 of the L-plane compression section 540 receives an instruction from an user to switch between a high-speed mode and a normal mode, and switches between the normal mode that goes through Huffman encoding by the Huffman encoding section 541 and the high-speed mode in which the lower-order sub-plane D1L is directly outputted while omitting the Huffman encoding. Accordingly, ultimately from the L-plane compression section 540, in the normal mode, the lower-order compressed data D2L in which the lower-order sub-plane D1L is compressed by the Huffman encoding is outputted, and in the high-speed mode, the lower-order compressed data D2L that is not subjected to the Huffman encoding and the lower-order sub-plane D1L is outputted substantially as it is.

On the other hand, the H-plane compression section 550 includes a run-length encoding section 551, a data scanning section 552, and a Huffman encoding section 553. The higher-order sub-plane D1H is inputted into the run-length encoding section 551.

In the run-length encoding section 551, firstly, in the higher-order sub-plane D1H that is inputted, the presence of one or plural to-be-compressed numeric values and the number of consecutive pieces of identical to-be-compressed numeric value are detected. Subsequently in the run-length encoding section 551, upon receipt of a result of the detection, encoding processing is performed such that, in the data of the higher-order sub-plane D1H, a to-be-compressed numeric value having a numeric value other than a specific value is directly outputted as it is, and also a to-be-compressed numeric value having the specific value is outputted by being encoded into the specific value and a numeric value representing the number of consecutive pieces of the specific value. In the run-length encoding section 551, at the time of the encoding processing, according to a number of consecutive pieces of an identical to-be-compressed numeric value, encoding is performed in which the number of consecutive pieces is expressed in a different bit number. Here, specifically, when a number of consecutive pieces of an identical to-be-compressed numeric value is equal to or smaller than a predetermined number, the number of consecutive pieces is expressed in a one unit bit number, whereas when the number of consecutive pieces is greater than the predetermined number, the number of consecutive pieces is expressed in a two unit bit number.

The data after being encoded by the run-length encoding section 551 is subsequently inputted into both the data scanning section 552 and the Huffman encoding section 553. In the data scanning section 552, all the data after being encoded by the run-length encoding section 551 is scanned and frequencies of occurrence (histogram) are determined for all numeric values occurring in the data. Here, in the present embodiment, this processing of obtaining the frequencies of occurrence is performed for each higher-order sub-plane D1H illustrated in FIG. 1 as a unit, and frequencies of occurrence of numeric values in the data after being encoded by the run-length encoding section 551, for each higher-order sub-plane D1H, are obtained. In addition, the data scanning section 552 allocates, based on the obtained data histogram (frequency of occurrence of a numeric value), a code with a shorter code length for a numeric value with a greater frequency of occurrence.

The Huffman table in which codes are allocated to numeric values by the data scanning section 552 is passed to the Huffman encoding section 553. The Huffman encoding section 553 performs encoding processing to replace a numeric value forming the data inputted into the Huffman encoding section 553 with a code according to the Huffman table. Namely, the encoding in which a numeric value with a greater frequency of occurrence is expressed in a code with a shorter bit length is performed.

The data after being Huffman-encoded in the Huffman encoding section 553 is attached with compression information including the allocation table of the numeric values and codes allocated by the data scanning section 552, to be outputted from the H-plane compression section 550 as a higher-order compressed data D2H in which the higher-order sub-plane D1H is compressed.

A group of the lower-order compressed data D2L and the higher-order compressed data D2H each being respectively outputted by the L-plane compression section 540 and the H-plane compression section 550 in this manner, forms reversibly compressed data (TRUE pixel compression plane) in which TRUE pixel data is reversibly compressed. This reversibly compressed data is inputted into the data transmission section 570.

On the other hand, the FAKE pixel data obtained by the thinning processing section 505 is inputted into the FAKE-pixel compression section 560 and subjected to the irreversible compression processing. This FAKE-pixel compression section 560 corresponds to an example of the second compression section according to the present invention, and the processing in the FAKE-pixel compression section 560 corresponds to an example of the second compression step according to the present invention. The FAKE-pixel compression section 560 includes a bit reducing section 561, a run-length encoding section 562, a Huffman encoding section 563, and a data scanning section 564. The numeric values forming the FAKE pixel data are replaced with either a 1-bit code or a 4-bit code by the bit reducing section 561. At this time, code replacing methods are different from one another depending on whether or not a pixel belongs to an edge portion detected by the edge detection section 525. In this way, after the numeric values are replaced with a code of either 1-bit or 4-bit, processing that is exactly same as the processing in the H-plane compression section 550 is performed by the run-length encoding section 562, the Huffman encoding section 563, and the data scanning section 564. As a result, an irreversibly compressed data D3 (FAKE pixel compression plane) in which the FAKE pixel data is irreversibly compressed is outputted from the FAKE pixel compression section 560. This irreversibly compressed data D3 is also inputted into the data transmission section 570.

By the reversibly compressed data of the TRUE pixel data and the irreversibly compressed data of the FAKE pixel data, compressed data representing a still image of a frame for the original image data is formed. Further, compressed data of moving picture data is formed by a series of compressed data corresponding to a series of frames. Such compressed data of the moving picture is transmitted by the data transmission section 570.

The data transmission section 570 transmits the reversibly compressed data of the TRUE pixel data (TRUE pixel compression plane) and the irreversibly compressed data of the FAKE pixel data (FAKE pixel compression plane) for each frame in this order. The data transmission section 570 corresponds to an example of the data transmission section of the present invention, and the processing in the data transmission section 570 corresponds to an example of the data transmission step of the present invention.

In a destination of the transmission, the compressed data is subjected to data decompression processing to be utilized for displaying a moving picture and the like. At the time of this data decompression processing, decode processing corresponding to various types of encode processing illustrated in FIG. 1 is applied to reproduce a series of image data that is sufficiently close to a series of the image data representing the original moving picture is restored, so that the original moving picture is reproduced in the high image quality. Furthermore, for example, if required for security purpose, it is also utilized for reproducing a still image that is almost the same as the original still image of a desired moment in the moving picture.

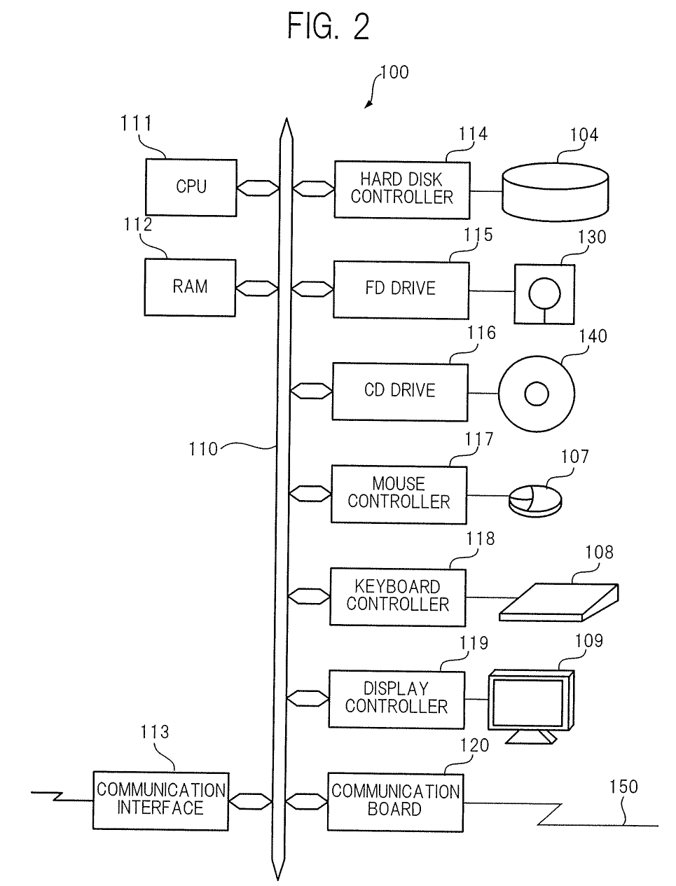

FIG. 2 is a schematic hardware diagram of a personal computer in which a moving picture compression transmission apparatus of the present invention is constructed.

A personal computer 100 illustrated in FIG. 2 includes a CPU 111, a RAM 112, a communication interface 113, a hard disk controller 114, a FD drive 115, a CD drive 116, a mouse controller 117, a keyboard controller 118, a display controller 119, and a communication board 120, and these components are connected to one another by a bus 110.

The hard disk controller 114 controls an access of a hard disk 104 incorporated in this personal computer 100. The FD drive 115 accesses a flexible disk (FD) 130 and the CD drive 116 accesses a CD type medium 140 represented by a CD-ROM, which are removably loaded in the personal computer 100. The mouse controller 117 and the keyboard controller 118 play a role of detecting operations of a mouse 107 and a keyboard 108 provided to the personal computer 100 to transmit the operations to the CPU 111. In addition, the display controller 119 plays a role of displaying an image on a display screen of an image display 109 provided in the personal computer 100 based on an instruction of the CPU 111.

The communication board 120 plays a role of communications compliant with a common interface protocol such as SCSI, and is also responsible for transmitting moving picture data after being compressed to another device via an interface cable 150.

Further, the communication interface 113 is responsible for common communications such as the Internet, and the personal computer 100 may also transmit moving picture data via this communication interface 113.

In the RAM 112, a program stored in the hard disk 104 is read out and expanded to be executed by the CPU 111. The CPU 111 reads out the program expanded in the RAM 112 and executes the program.

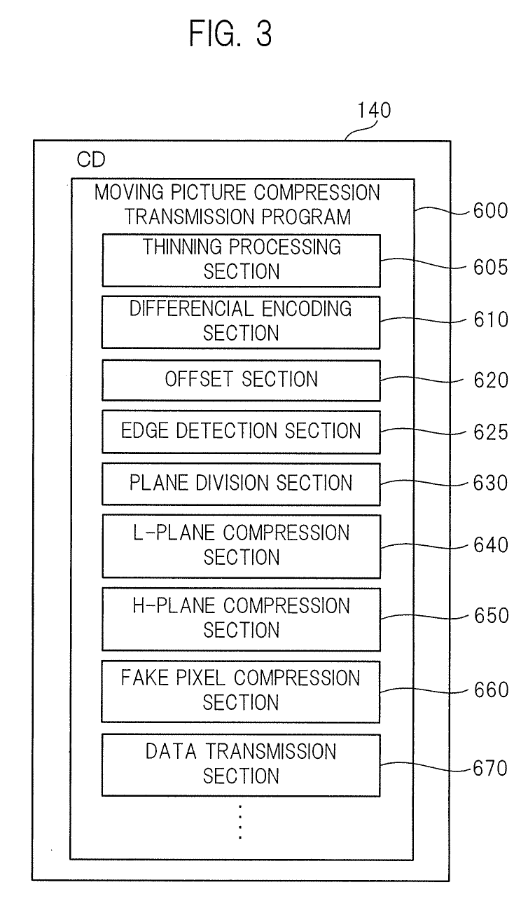

FIG. 3 is a schematic diagram of a moving picture compression transmission program corresponding to an embodiment of the moving picture compression transmission program of the present invention.

Here, this moving picture compression transmission program 600 is stored in the CD type medium 140. However, for a storage medium storing the moving picture compression transmission program of the present invention, any type of medium may be used as long as the medium may store the program. For example, a magnetic disk in a hard disk device may be used, or a flexible disk, an MO disk, and a DVD may be also used, or a card type storage medium and a tape type storage medium may be also used. In addition, the moving picture compression transmission program of the present invention is not limited to a program stored in a storage medium, but the moving picture compression transmission program may be a program communicated via a communication line.

The moving picture compression program 600 includes a thinning processing section 605, a differential encoding section 610, an offset section 620, an edge detection section 625, a plane division section 630, a L-plane compression section 640, a H-plane compression section 650, a FAKE pixel compression section 660, and a data transmission section 670.

This CD type medium 140 illustrated in FIG. 3 is mounted in the personal computer 100 illustrated in FIG. 2, and accessed by the CD drive 116. And the program stored in the CD type medium 140 is uploaded to the personal computer 100 and stored in the hard disk 104. When the program stored in the hard disk 104 is read out from the hard disk 104, expanded in the RAM 112 and executed by the CPU 111, this personal computer 100 operates as the moving picture compression apparatus 500 illustrated in FIG. 1.

Here, the moving picture compression transmission program 600 illustrated in FIG. 3 is installed in the personal computer 100 and executed by the CPU 111, thereby realizing, in the personal computer 100, the moving picture compression apparatus 500 illustrated in FIG. 1. The thinning processing section 605, the differential encoding section 610, the offset section 620, the edge detection section 625, the plane division section 630, the L-plane compression section 640, the H-plane compression section 650, the FAKE pixel compression section 660, and the data transmission section 670 are program components executed by the CPU 111, thereby causing the personal computer 100 to be operated as the thinning processing section 505, the differential encoding section 510, the offset section 520, the edge detection section 525, the plane division section 530, the L-plane compression section 540, the H-plane compression section 550, the FAKE pixel compression section 560, and the data transmission section 670, respectively, included in the moving picture compression apparatus 500 illustrated in FIG. 1. That is, by these program components, constituent elements of the moving picture compression apparatus 500 are substantially constructed on the personal computer 100.

The functions when each section 605 through 670 included in the moving picture compression transmission program 600 illustrated in FIG. 3 are executed by the CPU 111 are same as the functions of each section 505 through 570 included in the moving picture compression apparatus 500 illustrated in FIG. 1. Therefore, the explanation in the above and detailed explanation hereafter regarding each section 505 through 570 of the moving picture compression transmission apparatus 500 illustrated in FIG. 1 also serves as an explanation of each section 605 through 670 included in the moving picture compression transmission program 600 illustrated in FIG. 3.

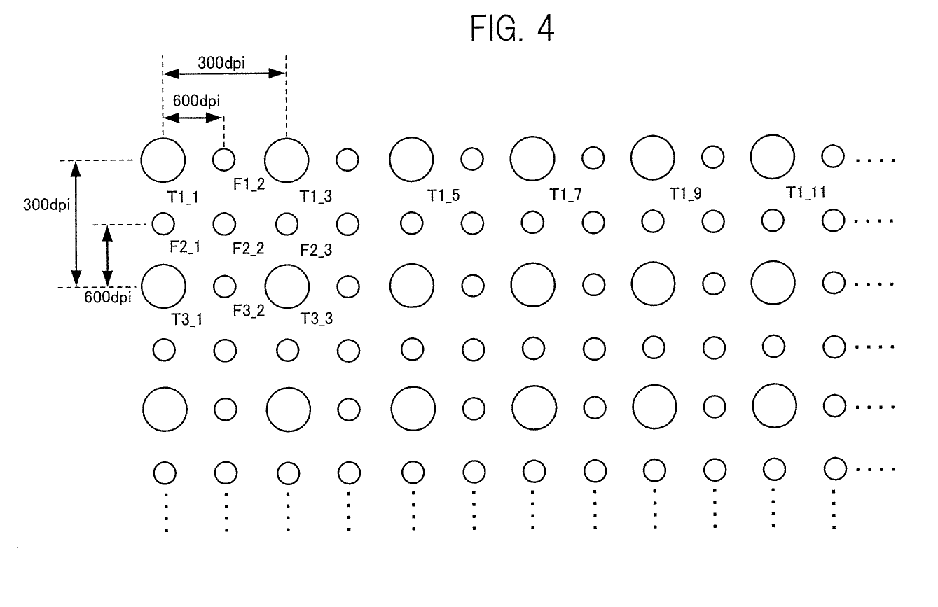

FIG. 4 is a diagram illustrating a data structure of image data inputted into the moving picture compression transmission apparatus 500 in FIG. 1 and a concept of thinning processing.

As illustrated in FIG. 4, in the image data inputted into the moving picture compression apparatus 500 illustrated in FIG. 1, pixels are aligned in a predetermined main scanning direction (horizontal direction in the figure) and a sub-scanning direction (vertical direction in the figure) at a right angle to the main scanning direction, and a pixel row aligned in the main scanning direction is called a line. Here, 8 lines of pixels are illustrated, and a distance between the pixels corresponds to a resolution of 600 dpi.

The position of each pixel is expressed by a subscript added to codes T and F each representing a pixel value. For example, in the third line, subscripts of 3_{—}1, 3_{—}2, 3_{—}3, 3_{—}4 and so on are sequentially added to the respective pixel values aligned in the main scanning direction.

The image data made up of the pixel values aligned in this manner is inputted into the thinning processing section 505 of the compression processing section 500 illustrated in FIG. 1, and the thinning processing section 505 classifies the respective pixels into the TRUE pixels and the FAKE pixels. The TRUE pixels among the pixels illustrated in FIG. 4 are each represented by the code T, whereas the FAKE pixels among the pixels illustrated in FIG. 4 are each represented by the code F. The TRUE pixels are periodically taken out from the aligned pixels, and this figure illustrates that in every other line (odd-numbered line) along the sub-scanning direction, every other TRUE pixel (odd-numbered pixel) along the main scanning direction is taken out as the TRUE pixel. As a result, the TRUE pixels are equivalent to pixels of an image whose resolution is deteriorated to a half of the original resolution, and the pixels corresponding to a quarter of the original image data are taken out. The TRUE pixels taken out in this manner form TRUE pixel data made up of a series of such TRUE pixels, and like the original image data, the TRUE pixel data has such a structure that the pixels are aligned in the main scanning direction and the sub-scanning direction. Also, the FAKE pixels left by taking out the TRUE pixels form FAKE pixel data made up of a series of such FAKE pixels.

As taking-out methods of TRUE pixels, other than the above, for example, a method in which pixels are taken out from one of every three pixels in the main scanning direction and form one of every three lines in the sub-scanning direction, thereby pixels corresponding to one ninth of pixels of the original image data are selectively taken out may be employed, and a method in which a taking out frequency in the main scanning direction is different from the sub-scanning direction may be employed. However in the description below, as illustrated in FIG. 4, it is assumed that odd numbered pixels in odd numbered lines are selectively taken out.

The frequency in which the thinning processing section 505 takes out the TRUE pixels is the same for each frame of a moving picture. However, positions (phases) where pixels are taken out vary among the frames.

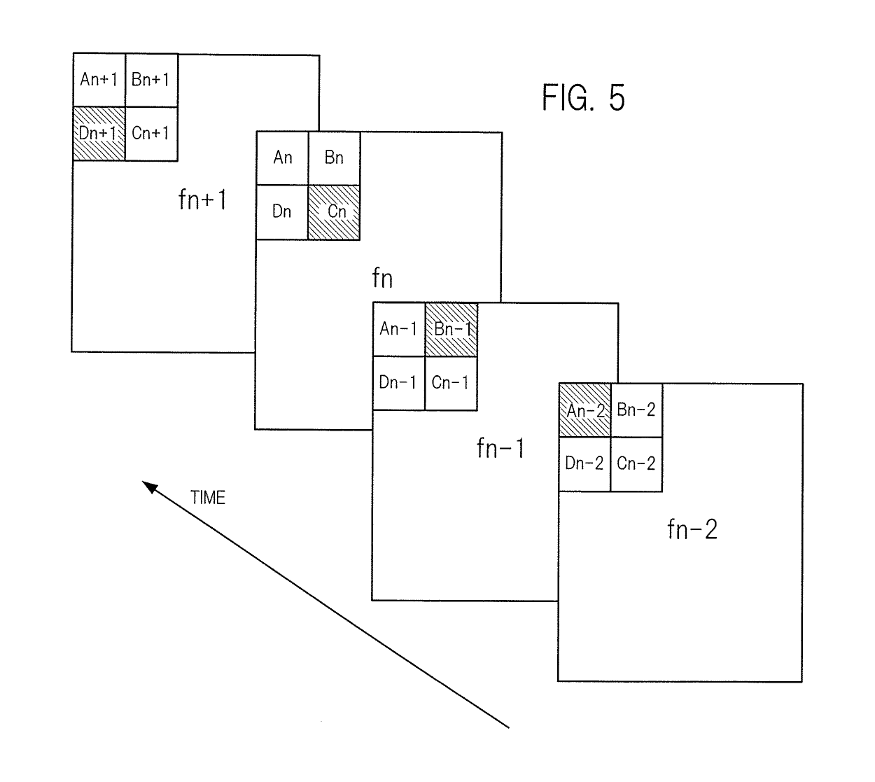

FIG. 5 is a diagram explaining change of positions where pixels are selectively taken out in each frame.

In FIG. 5, a view in which frames fn−2, fn−1, fn, fn+1 which constitute a moving picture are aligned along a time axis is conceptually illustrated. In the upper left portion of each frame fn−2, fn−1, fn, fn+1, 4 pixels per frame, An−2, Bn−2, Cn−2, Dn−2; An−1, Bn−1, Cn−1, Dn−1; An, Bn, Cn, Dn; An+1, Bn+1, Cn+1, Dn+1 are illustrated. These pixels are located in the same position (upper left portion) on the image of each of the frames fn−2, fn−1, fn, fn+1 which are aligned temporally next to each other, and correspond to the 4 pixels T1_1, F1_2, F2_1, F2_2 illustrated at upper left portion of the data structure illustrated in FIG. 4. In the data structure illustrated in FIG. 4, the upper left pixel T1_1 of the 4 pixels T1_1, F1_2, F2_1, F2_2 is the TRUE pixel. On the other hand, in each frame fn−2, fn−1, fn, fn+1 illustrated in FIG. 5, a shaded pixel of 4 pixels illustrated in one frame is the TRUE pixel. In short, the positions of TRUE pixels on frames temporally next to each other are different, and the position of TRUE pixel moves 1 pixel or 1 line every frame. As a result, the position of TRUE pixel goes around clockwise on the image every 4 frames as time goes on. Such movement of the TRUE pixel is the same for all the TRUE pixels on the image. Therefore, an alignment frequency of the TRUE pixels does not change, and only an alignment phase changes every frame. As will be mentioned later, although reversible compression is performed on the TRUE pixel data including a series of TRUE pixels, and irreversible compression is performed on the FAKE pixel data including a series of FAKE pixels, when the position of TRUE pixel moves as illustrated in FIG. 5, temporally averaged image quality of each pixel on the image is homogenized. There is a moment when data is reversibly compressed in every pixel on the image, and by collecting such reversible data portions from frames while the TRUE pixel goes around (for example, 4 frames as illustrated in FIG. 5), a still image of approximately the same quality may be reproduced at any moment of the moving picture.

Here, the explanation of the present embodiment is once interrupted, and an example of a radiographic image diagnosis system in which the moving picture compression transmission apparatus 500 in the present embodiment is further applied will be described. Recently, in a radiographic image diagnosis system, shooting is performed by not only a still image, but also by a moving picture.

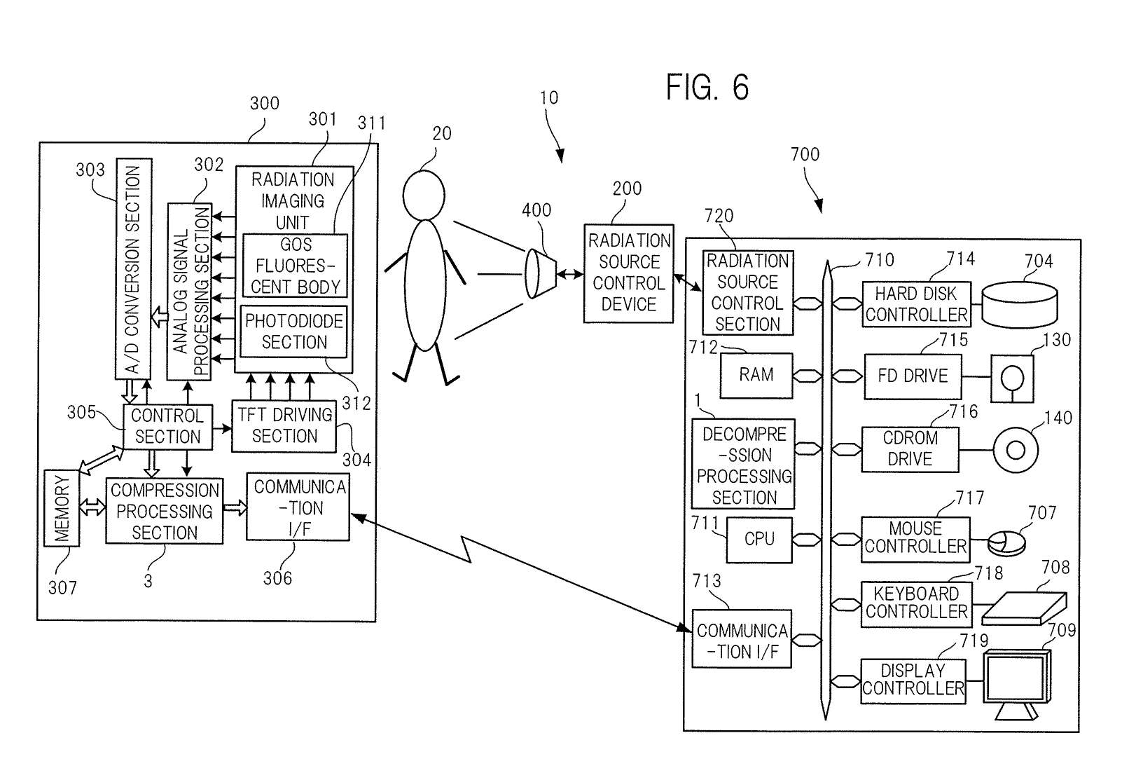

FIG. 6 is a schematic diagram of a radiographic image diagnosis system.

A radiographic image diagnosis system 10 illustrated in FIG. 6 includes a X-ray source 400, a radiation source control device 200, a radiation detection unit 300, and a system controller 700.

The emission of X-ray is controlled in the X-ray source 400 by the radiation source control device 200. The radiation detection unit 300 detects a radiation image according to a radiation emitted from the radiation source 400 and passing through a subject 20, after converting the detected radiation image to image data in digital, further compresses the image data and transmits it wirelessly to the system controller 700. The system controller 700 decompresses the transmitted compressed data, and displays the radiation image on a display based on the decompressed image data.

The system controller 700 illustrated in FIG. 6 includes a CPU 711, a RAM 712, a communication interface (hereafter, interface is abbreviated as I /F) 713, a hard disk controller 714, a FD drive 715, a CDROM drive 716, a mouse controller 717, a keyboard controller 718, a display controller 719, a radiation source control section 720, and a decompression processing section 1, which are connected to one another by a bus 710.

The hard disk controller 714 controls access of a hard disk 704 incorporated in this system controller 700. The FD drive 715 accesses the flexible disk (FD) 130 and the CDROM drive 716 accesses the CD type medium 140, which are removably loaded in the system controller 700. The mouse controller 717 and the keyboard controller 718 play a role of detecting operations of a mouse 707 and a keyboard 708 provided in the system controller 700 to transmit to the CPU 711. In addition, the display controller 719 plays a role of displaying an image on a display screen of an image display 709 provided in the system controller 700 based on an instruction of the CPU 711.

The communication I/F 713 is responsible for wireless communications between the previously described radiation detection unit 300 and the system controller 700, and the system controller 700 takes in compressed image data via the communication I/F 713 and transmits an instruction to the control section 305 of the radiation detection unit 300 via the communication I/F 713, as will be described later.

In the RAM 712, a program stored in the Hard Disk 704 is read out and expanded for execution by the CPU 711. The CPU 711 executes the program expanded in the RAM 712.

The radiation source control section 720 transmits an instruction about the radiation by the X-ray source 400 to the radiation source control device 200, and the radiation source control device 200 controls the X-ray source 400 according to the received instruction.

The decompression processing section 1 decompresses and restores the compressed image data which is transmitted from the radiation detection unit 300 and received via the communication I/F 713 to the image data before the compression. The above-described RAM 712 holds information to be used for restoring the received compressed image data into image data before the compression.

The CPU 711 controls each section of the system controller 700 and also controls the radiation detection unit 300.

The radiation detection unit 300 includes a radiation imaging unit 301, an analog signal processing section 302, an analog/digital (hereafter, analog/digital is abbreviated as A/D) conversion section 303, a thin-film transistor (hereafter, thin-film transistor is abbreviated as TFT) driving section 304, the control section 305, a communication I/F 306, a memory 307, and a compression processing section 3.

The radiation imaging unit 301 includes a GOS fluorescent body 311 made of a gadolinium oxide sulfate compound (hereafter, the gadolinium oxide sulfate compound is abbreviated as GOS) and a photodiode section 312 including plural photodiodes formed for each grid point on a TFT array. The GOS fluorescent body 311 converts the radiation emitted from the X-ray source 400 and passing through the subject 20 to visible light according to the magnitude of energy. In the photodiode section 312, the plural photodiodes store electric charge according to the visible light. The analog signal processing section 302 includes an operational amplifier and a capacitor to convert the electric charge into the analog electric signal. The TFT driving section 304 is a switching means and with switch on, causes the GOS fluorescent body 311 to emit light in accordance with the energy of received radiation and causes the photodiode section 312 to convert this light into the electric charge. The electric charge is converted into the analog electric signal in the analog signal processing section 302, and then inputted to the A/D conversion section 303 for being converted into digital data to be outputted. The digital data is inputted to the compression processing section 3 via the control section 305.

The compression processing section 3 includes, although illustration is omitted, a data command port for inputting digital data and command data from the control section 305, a line buffer with a capacity for several lines out of the radiographic image data for one frame, a code buffer in which necessary information at the time of compression processing is hold, and a register into which a state of the compression processing section per se is written and an instruction to the compression processing section 3 is written and the like. Furthermore, the compression processing section 3 has an equivalent function to that of the above-described moving picture compression transmission apparatus 500, and compresses a data amount of digital data to record in the memory 307 and transmits to the system controller side per one line of the data via the communication I/F 306. As previously described, from the CPU 711 of the system controller 700, command data is transmitted wirelessly to the control section 305 of the radiation detection unit 300. The control section 305 causes, following an instruction from the CPU 711 of the system controller 700, the TFT driving section 304, the analog signal processing section 302 and the A/D conversion section 303 to be driven, compression processing by the compression processing section 3 to be performed, transmission of the compressed data by the communication I/F 306 or storing into the memory 307 and the like to be performed.

As described above, in such a radiographic image diagnosis system, recently, shooting is performed by not only a still image, but also by a moving picture.

Generally a moving picture has a large amount of data and in order to increase an image frame rate, the data is transmitted in an irreversible compression schema with less data amount. However, in the medical field, there is often a need to stop a moving picture to watch a still image while displaying the moving picture. In such a case, with a general irreversible compression schema (JPEG and so on), the still image becomes a still image also in the irreversible state (loss of data is generated in the original data), which is inappropriate for medical diagnosis. In this case, in a worst-case for the diagnosis, a repeated shooting for the still image may be required.

On the other hand, according to this radiographic image diagnosis system in which the moving picture compression transmission apparatus 500 is applied, it is possible to reproduce the still image at any moment in a moving picture at substantially the same level of image quality, by collecting reversible data portions for frames in which TRUE pixels go one around (for example, such as four frames illustrated in FIG. 4), which may be used for the still image for diagnosis, so that there is no need to repeat the shooting.

Hereafter, returning to the explanation of the moving picture compression transmission apparatus 500 illustrated in FIG. 1 and reversible compression processing to TRUE pixel data will be explained.

Firstly, in the reversible compression processing, the TRUE pixel data is inputted into the differential encoding section 510 of the moving picture compression transmission apparatus 500 in FIG. 1 and subjected to the two-dimensional differential encoding processing to obtain a further difference in the sub-scanning direction as to the differences between pixels adjacent to each other in the main scanning direction.

This two-dimensional differential encoding processing will be explained in detail.

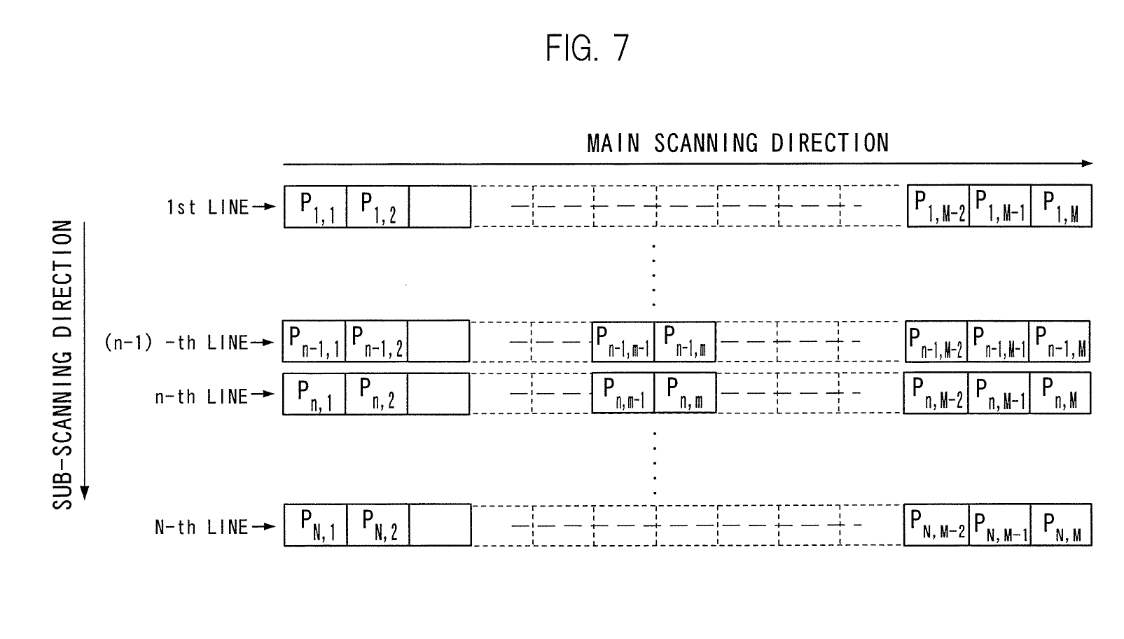

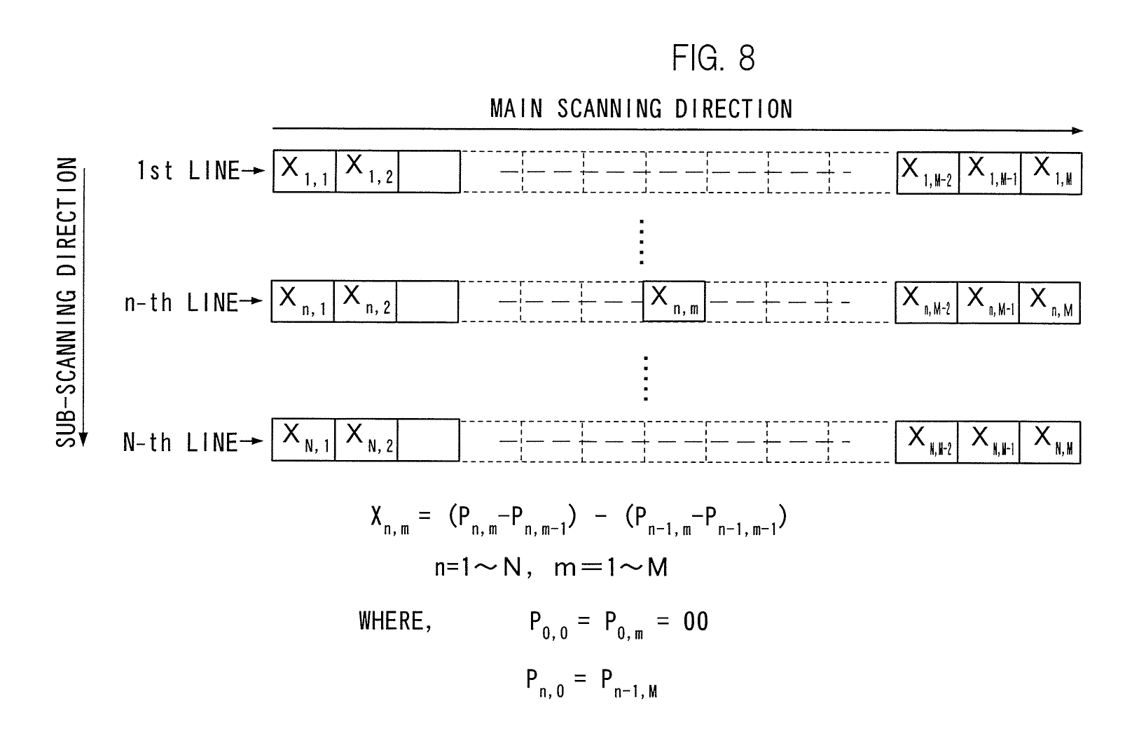

FIG. 7 is a diagram illustrating a structure of the TRUE pixel data inputted into the differential encoding section 510, and FIG. 8 is a diagram illustrating a data structure after the TRUE pixel data is subjected to two-dimensional differential encoding processing.

TRUE pixel data is, as described above, one type of image data that represents an image in low resolution made of pixels that are thinned out from the image. An image represented by TRUE pixel data has such a structure that N lines, each of which is made up of M pixels aligned in a predetermined main scanning direction, are aligned in a sub scanning direction orthogonal to the main scanning direction. The image data reflects such a structure and thus also is configured such that N lines, each of which is made up of M pixel values aligned in the main scanning direction (a lateral direction in the figure), are aligned in the sub scanning direction (a vertical direction in the figure) as illustrated in FIG. 7. In this FIG. 7, the m-th pixel value from left in the n-th line from top is indicated by Pn,m. By using this notation, in the line at the n-th position in the sub-scanning direction, pixel values of the respective pixels aligned in the main scanning direction are indicated by P_{n,1}, P_{n,2}, . . . , P_{n,m-1}, P_{n,m}, . . . , P_{n,M-2}, P_{n,M-1}, P_{n,M} in the alignment order. These pixel values are numeric values expressed in hexadecimal notation.

Here, the image data described above is inputted into the differential encoding section 510 illustrated in FIG. 1, where the image data is subjected to the two-dimensional differential encoding processing to obtain a further difference in the sub-scanning direction as to the differences between pixels adjacent to each other in the main scanning direction.

FIG. 8 illustrates the structure of the data after being subjected to the two-dimensional differential encoding processing. This data also has such a structure that N lines, each of which is made up of M pixel values after the two-dimensional differential encoding, are aligned in the main scanning direction. In FIG. 8, the m-th pixel value, from left in the n-th line from the top, after being subjected to the two-dimensional differential encoding, is denoted in X_{n,m}. This pixel value X_{n,m} after the two-dimensional differential encoding is obtained from four pixel values (P_{n-1,m-1}, P_{n-1,m}, P_{n,m-1}, P_{n,m}) before the two-dimensional differential encoding illustrated in a central part of FIG. 7, based on a conversion formula shown below.

X_{n,m}=(P_{n,m}−P_{n-1,m})−(P_{n-1,m}−P_{n-1,m-1}) (1)

Here, in a case of n=1 or m=1, 0 appears as the subscript of the pixel value before the two-dimensional differential encoding on the right side. The pixel value whose subscript is 0 is defined as follows.

P_{0,0}=P_{0,m}=0000(m=1 to M), P_{n,0}=P_{n-1,M}, (n=1 to N) (2)

Here, “0000” of the formula (2) indicates that the value is zero when the pixel value is expressed in hexadecimal notation. In the following, the meanings of the formula (1) and the formula (2) will be briefly described.

The formula (1) indicates that the pixel value X_{n,m} after the two-dimensional differential encoding is obtained by the further difference, in the sub-scanning direction, of the difference (i.e., a value in the parenthesis) between pixels adjacent to each other in the main scanning direction. When the correlation between the pixel value P_{n,m} before the two-dimensional differential encoding and its adjacent pixel value is strong (i.e., when these pixel values are similar to each other in terms of size), the pixel value X_{n,m} after the two-dimensional differential encoding is close to zero.

The formula (2) represents the definition of each pixel value when a virtual 0th line in the sub-scanning direction and a virtual pixel value at the 0th position from left in each line are newly provided. In this definition, as to the main scanning direction, the pixel value at the left edge (the 0th pixel value P_{n,0} from left) and the pixel value P_{n-1,M} at the right edge in a line before the line where the pixel value at the left edge is present are regarded as identical. Further, in this definition, as to the sub-scanning direction, the uppermost pixel value in the diagram (the pixel value in the 0th line), namely P_{0,0} and P_{0,m} are fixed to 0.

In the data after the two-dimensional differential encoding, as to the pixel value in the first line and the first pixel value in each line, a term where a subscript is “0” appears in the right side of the conversion formula (1). Therefore, the definition of the formula (2) is applied. To be more specific, the pixel value in the first line after the two-dimensional differential encoding is expressed as shown below based on the formula (1) and the formula (2).

X_{1,1}=P_{1,1},

X_{1,2}=P_{1,1}−P_{1,11},

X_{1,3}=P_{1,3}−P_{1,2},

. . .

X_{1,M}=P_{1,M}−P_{1,M-1}

On the other hand, in the data after the two-dimensional differential encoding, the first pixel value of each line is expressed as shown below based on the formula (2).

X_{1,1}=P_{1,1},

X_{2,1}=(P_{2,1}−P_{1,M})−P_{1,1},

X_{3,1}=(P_{3,1}−P_{2,M})−(P_{2,1}−P_{1,M}),

. . .

X_{N,1}=(P_{N,1}−P_{N-1,M})−(P_{N-1,1}−P_{N-2,M})

In this way, as to the pixel value in the first line and the first pixel value in each line, the way of the conversion is slightly peculiar. However, to the pixel values other than these pixel values, the formula (1) is directly applied without the definition of the formula (2) being applied. For example, the pixel values except the pixel value at the left edge among the pixel values in the second line are each expressed as shown below.

X_{2,2}=(P_{2,2}−P_{2,1})−(P_{1,2}−P_{1,1}),

X_{2,3}=(P_{2,3}−P_{2,2})−(P_{1,3}−P_{1,2}),

. . .

X_{2,M}=(P_{2,M}−P_{2,M-1})−(P_{1,M}−P_{1,M-1})

This two-dimensional differential encoding processing will be described using concrete numeric values.

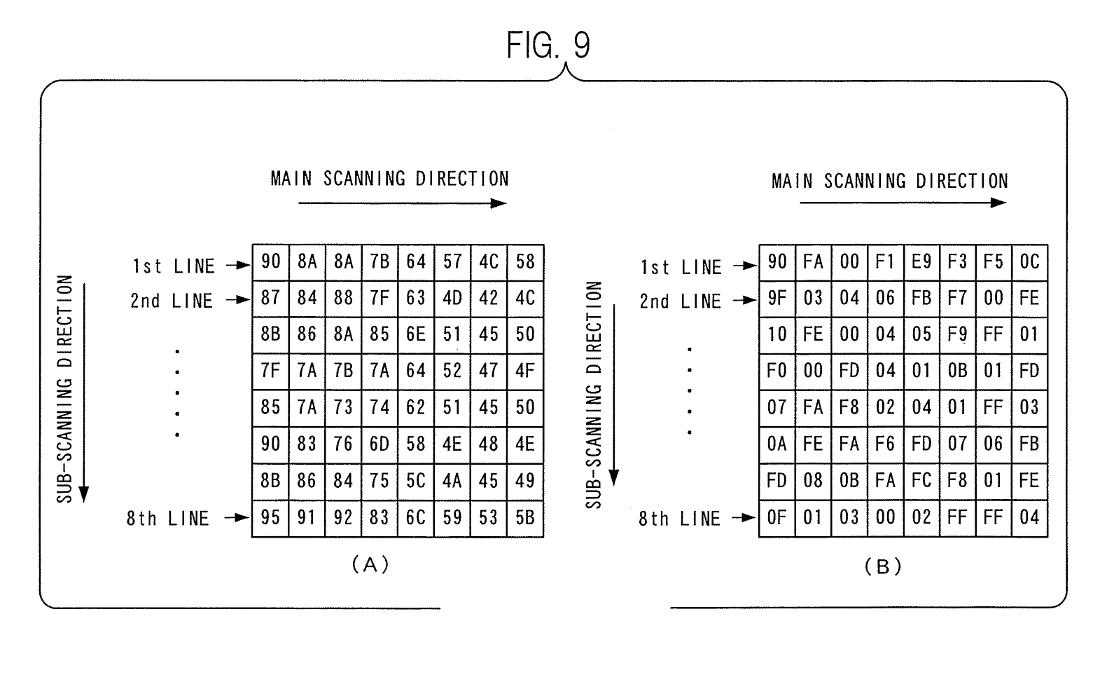

FIG. 9 is a diagram illustrating the two-dimensional differential encoding processing in the differential encoding section 510 in FIG. 1, by way of example.

Each numeric value illustrated on the left side of FIG. 9 (part (A)) is a pixel value of image data, whereas each numeric value illustrated on the right side of FIG. 9 (part (B)) is an output value that is outputted by the two-dimensional differential encoding processing. The lateral direction in FIG. 9 is the main scanning direction, and a row formed by eight numeric values aligned along the main scanning direction is the above-described line. The data illustrated in FIG. 9 includes eight lines in total, each having such eight numeric values aligned therein. This data is equivalent to data in a case where N=8, M=8 in the data in FIG. 7 and FIG. 8.

In the two-dimensional differential encoding processing applied to the data illustrated in part (A) of FIG. 9, at first, the leftmost “90” among pixel values “90 8A 8A 7B . . . ” in the first line is directly output as the above-mentioned X_{1,1} and as the remaining X_{1,2}, X_{1,3} and so on, differential values “8A−90=FA”, “8A−8A=00” and so on between pixel values adjacent to each other in the main scanning direction are output. Here, actually, the result of subtracting “90” from “8A” becomes a negative number and is represented by “1FA” in 9 bits. However, the higher-order “1” that is 1 bit of MSB is omitted, and only “FA” corresponding to lower-order 8 bits is outputted.

As to the second line, in the following formula to determine X_{2,1},

X_{2,1}=(P_{2,1}−P_{1,M})−P_{1,1}

where the numeric values illustrated in part (A) of FIG. 6 are substituted into (P_{2,1}, P_{1,8}, P_{1,1}) with defined as M=8 in the right side, and “(87−58)−90=9F” is outputted as X_{2,1}. As the remaining X_{2,2}, X_{2,3}, . . . , differences “(84−87)−(8A−90)=3”, “(88−84)−(8A−8A)=04”, . . . between the differences between the pixel values adjacent to each other in the main scanning direction in the second line and the differences between the pixel values adjacent to each other in the main scanning direction in the first line are outputted.

As to the third line, in the following formula to determine X_{3,1},

X_{3,1}=(P_{3,1}−P_{2,M})−(P_{2,1}−P_{1,M})

where the numeric values illustrated in part (A) of FIG. 9 are substituted into {P_{3,1}, P_{2,8}, P_{2,1}, P_{1,8}} with defined as M=8 in the right side, and “(8B−4C)−(87−58)=10” is outputted as X_{3,1}. As the remaining X_{3,2}, X_{3,3}, . . . , differences “(86−8B)−(84−87)=FE”, “(8A−86)−(88−84)=00”, . . . , between the differences between the pixel values adjacent to each other in the main scanning direction in the third line and the differences between the pixel values adjacent to each other in the main scanning direction in the second line are outputted.

As to the fourth line and thereafter as well, each numeric value illustrated in part (B) of FIG. 9 is obtained by repeating the operation same as that for the third line.

In the decompression processing to be applied to compressed moving picture data, decoding processing of data is performed to the data subjected to the two-dimensional differential decoding in this manner. In this decoding processing, a formula to determine P_{n,m} from the data after being subjected to the two-dimensional differential decoding is used, and this formula is obtained as follows.

A result of performing addition in the pixel value X_{i,j} after the two-dimensional differential encoding, from i=1 to i=m and further from j=1 to j=m, is expressed as the following formula (3), by using the formula (1) and the formula (2).

$$\begin{matrix}{\sum }_{i = 1}^{n} {\sum }_{j = 1}^{m} {X}_{i , j} = {\sum }_{i = 1}^{n} \{ {\sum }_{j = 1}^{m} ( {p}_{i , j} - {p}_{i , j - 1} ) - {\sum }_{j = 1}^{m} ( {p}_{i - 1 , j} - {p}_{i - 1 , j - 1} ) \} \\ = {\sum }_{i = 1}^{n} \{ ( {P}_{i , m} - {P}_{i , 0} ) - ( {P}_{i - 1 , m} - {P}_{i - 1 , 0} ) \} \\ = {\sum }_{i = 1}^{n} \{ ( {P}_{i , m} - {P}_{i - 1 , m} ) - ( {P}_{i , 0} - {P}_{i - 1 , 0} ) \} \\ = ( {P}_{n , m} - {P}_{0 , m} ) - ( {P}_{n , 0} - {P}_{0 , 0} ) \\ = {P}_{n , m} - {P}_{n - 1 , M}\end{matrix} \qquad ( 3 )$$

Here, to {P_{0,0}, P_{n,0}, P_{0,m}} appearing in the middle of the formula, the formula (2) is applied. Based on this formula, the pixel value P_{n,m} before the two-dimensional differential encoding is expressed as the following formula (4).

$${P}_{n , m} = {\sum }_{i = 1}^{n} {\sum }_{j = 1}^{m} {X}_{i , j} + {P}_{n - 1 , M} \qquad ( 4 )$$

In the personal computer illustrated in FIG. 1, at first, the pixel value P_{1,1}, P_{1,2}, . . . , P_{1,M} in the first line are determined by the formula (4). For example, by substituting n=1 into the formula (4) and further using P_{0,M}=0, the m-th pixel value in the main scanning direction among the pixel values in the first line is represented by the following formula (5).

$${P}_{1 , m} = {\sum }_{j = 1}^{m} {X}_{1 , j} \qquad ( 5 )$$

In this way, the pixel values P_{1,1}, P_{1,2}, . . . , P_{1,M} in the first line are all determined.

The pixel values P_{2,1}, P_{2,1}, . . . , P_{2,M} are obtained similarly by substituting n=2 into the formula (4) and using P_{1,M} obtained by the decoding of the pixel values in the first line. For example, the m-th pixel value in the main scanning direction among the pixel values in the second line is expressed by the following formula (6).

$${P}_{2 , m} = {\sum }_{j = 1}^{m} ( {X}_{1 , j} + {X}_{2 , j} ) + {P}_{1 , M} \qquad ( 6 )$$

The pixel values in the third line and thereafter also are similarly determined by using the pixel values decoded by the formula (6) and the computation thereafter. In the personal computer 4 illustrated in FIG. 1, the decoding processing of data is performed in this way.

In the differential encoding section 510 in FIG. 1, image data is subjected to the two-dimensional differential encoding as described above. The data obtained by this two-dimensional differential encoding is inputted into the offset section 520 in FIG. 1, a predetermined offset value is added to each numeric value of the data, and the data is divided into a lower-order sub-plane D1L and a higher-order sub-plane D1H. Here, processing up to the division of the data will be described by using a specific image as an example.

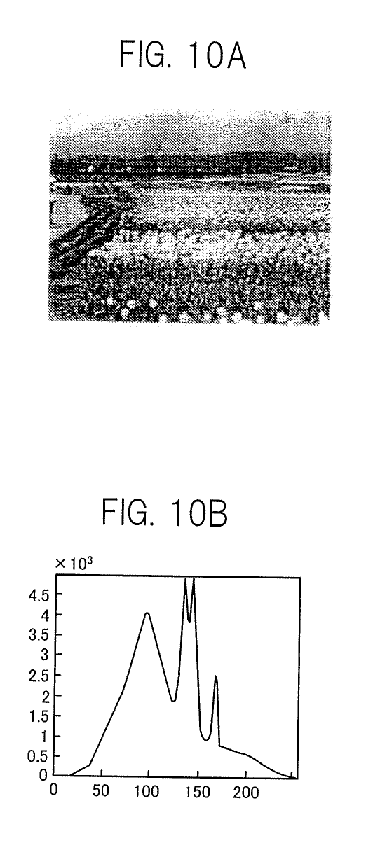

FIGS. 10A and 10B are diagrams illustrating an example of the image data.

In FIG. 10A, a monochrome scenic image is illustrated as an example of the image. In the present embodiment, there is used image data in which the color density in each pixel of such an image is expressed by an 8-bit numeric value. In FIG. 10B, there is illustrated a histogram of data values in the image data presenting the scenic image illustrated in FIG. 10A. The horizontal axis of this histogram represents the data value, while the vertical axis represents the number of pieces of data (the number of pixels). In a normal image, the width of the histogram is large, and peaks and valleys in the number of pieces of data appear, but it is extremely rare that an area where the number of pieces of data is “0” in the middle of the histogram is produced.

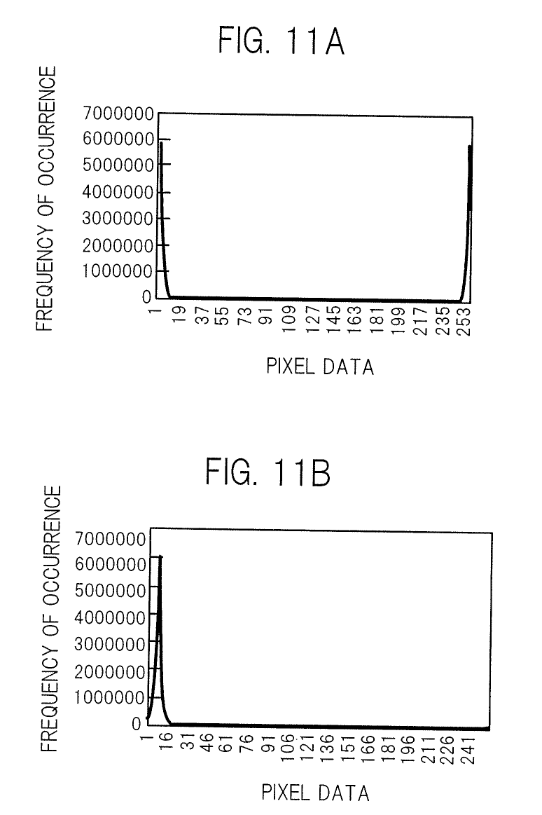

FIGS. 11A and 11B are diagrams illustrating differential encoding applied to the image data and an effect of the offset.

In FIG. 11A, there is illustrated a histogram of data obtained by subjecting the image data illustrated in FIG. 10A to the differential encoding. The horizontal axis of this histogram represents the data value, while the vertical axis represents the frequency of occurrence. When the image data is subjected to the differential encoding described with reference to FIG. 7 and FIG. 8, the histogram of the data generally has a sharp peak at each of the minimum data value and the maximum data value as illustrated in FIG. 11A. And, when such data is offset, the histogram of the data has a sharp peak at an offset value as illustrated in FIG. 11B. In the present embodiment, “8” is used as the offset value, and as a result of the offset, the frequencies of the data values more than “16” become almost “0”.

The data whose histogram is transformed by the differential encoding and the offset in this way is divided into the lower-order sub-plane D1L and the higher-order sub-plane D1H by the plane division section 530 in FIG. 1.

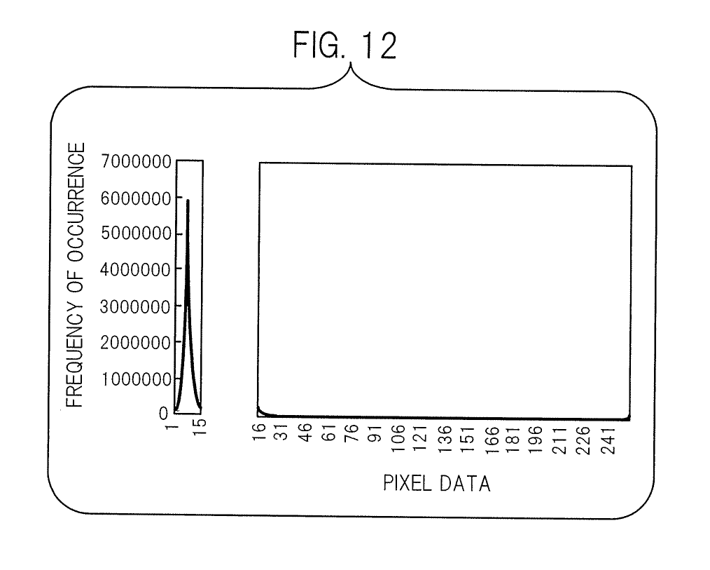

FIG. 12 is a diagram that explains an effect of the data division by the plane division section 530.

FIG. 12 illustrates a histogram obtained by dividing the histogram illustrated in FIG. 11B between the data value “15” or smaller and the data value “16” or lager. The data division by the plane division region 530 in FIG. 1 produces an effect equivalent to this division of the histogram. In other words, in the present embodiment, each of 8-bit numerical vales of the data is divided into higher-order 4 bits and lower-order 4 bits, so that there are obtained the lower-order sub-plane D1L made of consecutive numeric values represented by the lower-order 4 bits and the higher-order sub-plane D1H made of consecutive numeric values represented by the higher-order 4 bits. Further, when it is interpreted that the 4-bit numeric values of the lower-order sub-plane D1L directly represent the numeric values from “0” to “15”, and the 4-bit numeric values of the higher-order sub-plane D1H represent 16 types of numeric values at 16 intervals from value “16” to value “256”, the histogram of the lower-order sub-plane D1L is about the same as the histogram shown on the left side in FIG. 12, and the histogram of the higher-order sub-plane D1H is about the same as the histogram illustrated on the right side in FIG. 12. However, in the histogram of the higher-order sub-plane D1H, a peak having a height equal to an area of the histogram shown on the left side in FIG. 12 is added to the data value “16” of the histogram illustrated on the right side in FIG. 12.

In the following, processing of the data after being divided into the higher-order sub-plane D1H and the lower-order sub-plane D1L will be described.

First, the processing applied to the higher-order sub-plane D1H will be described.

As apparent from the fact that the frequencies of occurrence of the pixels in the histogram shown on the right side in FIG. 12 are almost zero, it is expected that many of the numeric values of the higher-order sub-plane D1H are consecutive values near zero (“00” and “01” and “FF” in hexadecimal notation). For this reason, in order to compress the higher-order sub-plane D1H, it is effective to perform run-length encoding in which compression is performed by encoding identical consecutive numeric values, and the higher-order sub-plane D1H is inputted into the run-length encoding section 551 that is one of the constituent elements of the H-plane compression section 550 illustrated in FIG. 1.

In the present embodiment, two continuous 4-bit numeric values of the higher-order sub-plane D1H are treated as a single 8-bit numeric value in the run-length encoding section 551 for convenience of processing, and consecutive numeric values from “00” to “FF” in hexadecimal notation are subjected to the following encoding processing.

In this encoding processing, only a particular numeric value of plural 8-bit numeric values is encoded. Therefore, in this run-length encoding section 551, a numeric value targeted for the encoding processing (here, this numeric value is referred to as a “to-be-compressed numeric value”) and the number of consecutive pieces of the to-be-compressed numeric values is detected among the received data.

In the present embodiment, for instance, three numeric values of “01”, “FF” and “00” are each used as the to-be-compressed numeric value.

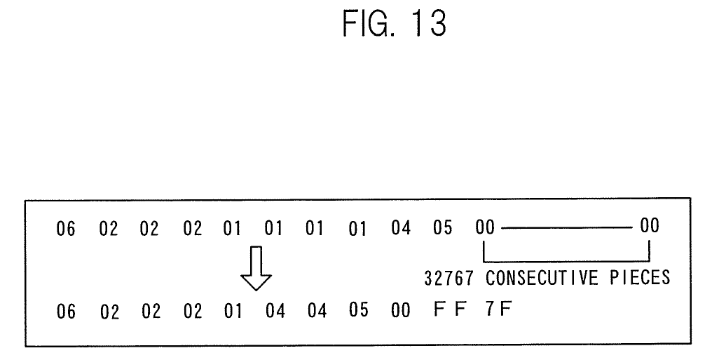

FIG. 13 is a diagram to explain the encoding in the run-length encoding section 551 illustrated in FIG. 1.

The upper line in FIG. 13 represents data of the higher-order sub-plane D1H, and the lower line represents data after being subjected to the encoding processing in the run-length encoding section 551.

Here, as illustrated in the upper line in FIG. 13, the data made of “06 02 02 02 01 01 01 01 04 05 00 . . . ” is assumed to be inputted from the run-length encoding section 551. At this time, in the run-length encoding section 551 in FIG. 1, there are detected: the head “06” as well as the next “02 02 02” as not being the to-be-compressed numeric values; the subsequent four consecutive pieces of “01” as being the to-be-compressed numeric values; and subsequently, after “04” and “05”, consecutive 32767 pieces of “00” as being the to-be-compressed numeric values.

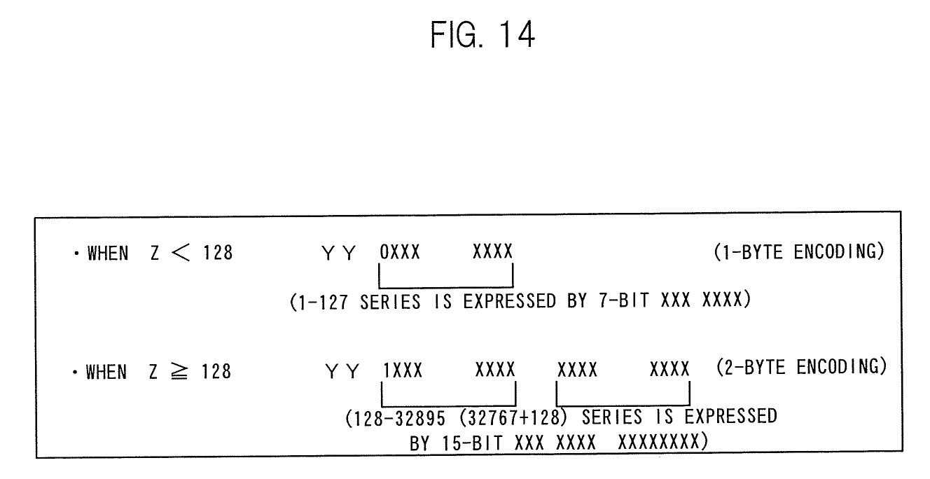

FIG. 14 is a diagram that illustrates an algorithm of the encoding that targets the to-be-compressed numeric values in the run-length encoding section.

In this FIG. 14, Z represents the number of consecutive identical pieces of the to-be-compressed numeric values. For example, in the upper line in FIG. 13, Z=4 for “01”, and Z=32,767 for “00”.

Further, in FIG. 14, “YY” represents the to-be-compressed numeric value per se in two-digit hexadecimal notation. Following “YY,” “0” or “1” is “0” or “1” expressed in 1 bit, and in “XXX XXXX . . . ” subsequent thereto, a single “X” represents 1 bit, and the value of Z is expressed by this “XXX XXXX . . . ”.

In other words, FIG. 14 means that when the to-be-compressed numeric value “YY” continues for Z<128 pieces, the first byte expresses the to-be-compressed numeric value “YY”, the first bit of the next one byte is “0”, and the subsequent 7 bits express the value of “Z”. Further, FIG. 14 means that when the to-be-compressed numeric value “YY” continues for Z>=128 pieces, the first byte expresses the to-be-compressed numeric value “YY”, the expression covers the next 2 bytes (16 bits) by placing “1” at the first bit, and the subsequent 15 bits express the value of “Z”.

An example of the encoding illustrated in FIG. 1 will be described according to the rule illustrated in FIG. 14.

The head numeric value “06” of the data (upper line) of the higher-order sub-plane D1H inputted from the plane division section 530 in FIG. 1 is not the to-be-compressed numeric value and therefore, this “06” is directly outputted. Also, “02” of “02 02 02” subsequent to the head “06” is not the to-be-compressed numeric value and thus, these three “02” also are directly outputted. Subsequently, there are four consecutive pieces of the to-be-compressed numeric value “01” and therefore, these are encoded into “01 04”. The next “04” and “05” are not the to-be-compressed numeric values and thus, “04 05” is directly outputted.

Subsequently, there are 32767 consecutive pieces of “00” and thus, “00” is placed, 1 bit at the head of the next 1 byte is turned to be “1”, and the next 15 bits are used to express 32767+128, so that there is expressed the fact that there are 32767 consecutive pieces of “00” by using 3 bytes of “00 FF 7F”. In other words, the number of consecutive pieces 128 is expressed by “00 00” except the first bit “1”.

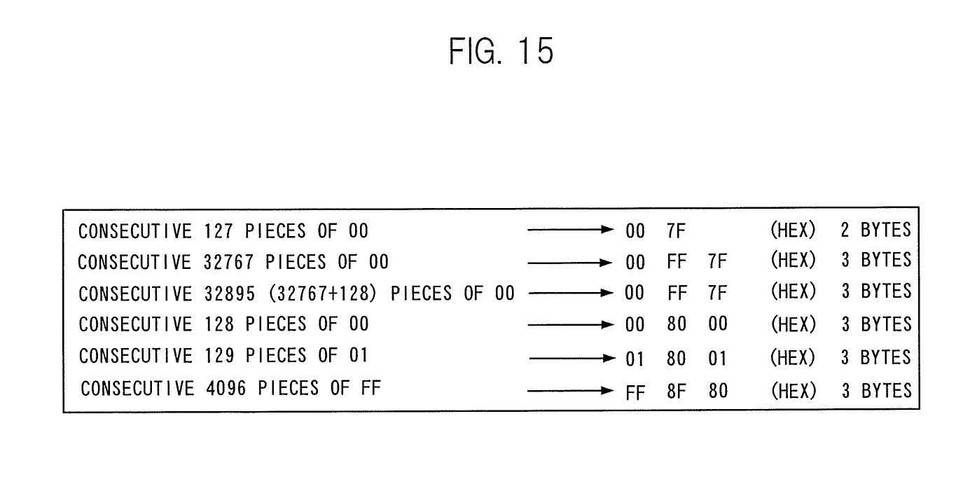

FIG. 15 is a diagram illustrating an example of encoding processing according to a number of consecutive pieces in the run-length encoding section 551 in FIG. 1.
When there are 127 consecutive pieces of “00”, these are encoded into “00 7F” using 2 bytes.
When there are 32767 consecutive pieces of “00”, these are encoded into “00 FF 7F” using 3 bytes.
When there are 32895 consecutive pieces of “00”, these are encoded into “00 FF FF” using 3 bytes.
When there are 128 consecutive pieces of “00”, these are encoded into “00 80 00” using 3 bytes.
When there are 129 consecutive pieces of “01”, these are encoded into “01 80 01” using 3 bytes.
When there are 4096 consecutive pieces of “FF”, these are encoded into “FF 8F 80” using 3 bytes.

In the run-length encoding section 551 illustrated in FIG. 1, the above-described encoding processing is performed.

According to the run-length encoding section 551 of the present embodiment, the maximum compression ratio improves up to 3/32895=1/10965. Also, as described with reference to the histogram in FIG. 12, in the data of the higher-order sub-plane D1H targeted for the encoding processing by this run-length encoding section 551, most of 4-bit numeric values are “0” expressing the data value “16”, and many of 8-bit numeric values made from the 4-bit numeric values also are “00” in hexadecimal notation. For this reason, great data compression is expected to be realized by the encoding processing in the run-length encoding section 551.

The data after being subjected to the encoding processing by the run-length encoding section 551 in the H-plane compression section 550 in FIG. 1 is subsequently inputted into the data scanning section 552 and the Huffman encoding section 553 of the H-plane compression section 550 in FIG. 1.

In this data scanning section 552, first, the whole data outputted from the run-length encoding section 551 is scanned, and the frequencies of occurrence of the data values are determined.

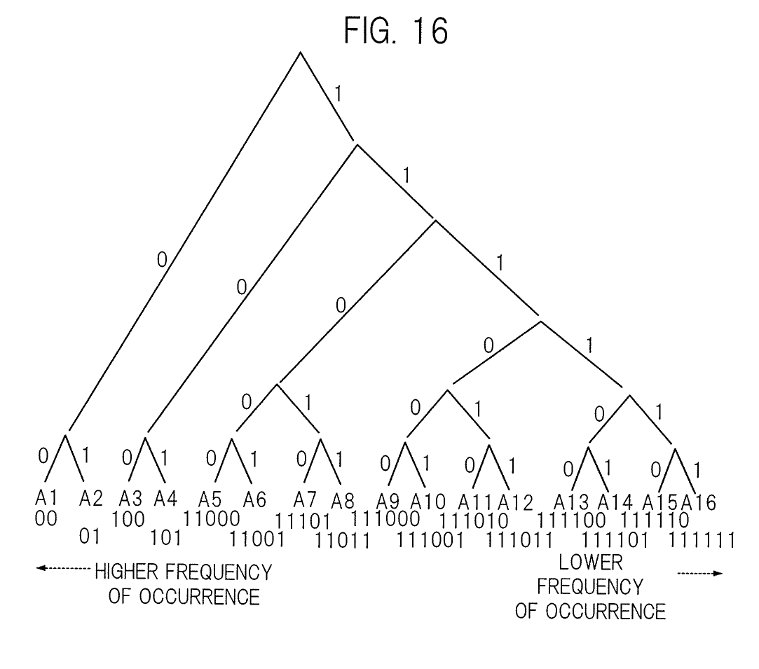

FIG. 16 is a diagram that illustrates an example of the result obtained by scanning of the data scanning section 552.

Here, the frequency of occurrence of “A1” is the highest, followed by “A2”, “A3”, “A4”, and so on sequentially. Incidentally, these “A1”, “A2” and the like do not directly represent numeric values and are codes to express the numeric values. In other words, for example, “A1” expresses a numeric value “00”, and “A2” expresses a numeric value “FF”. Also, here, for the sake of simplicity, all the data values of the data sent from the run-length encoding section 551 in FIG. 1 are assumed to be any one of 16 numeric values from “A1” to “A16”. Further, in the data scanning section 552, a code according to the frequency of occurrence is assigned to each of these 16 numeric values, and a Huffman table is created. In other words, a code “00” expressed in 2 bits is assigned to “A1” of the highest frequency of occurrence, and a code “01” expressed also in 2 bits is assigned to the next “A2”. Further, a code “100” and a code “101” each expressed in 3 bits are assigned to the next “A3” and “A4”, respectively, and each code expressed in 5 bits is assigned to each of the next “A5” to “A8”. Thereafter, similarly, a code expressed in the larger number of bits is assigned to the numeric value whose frequency of occurrence is lower.

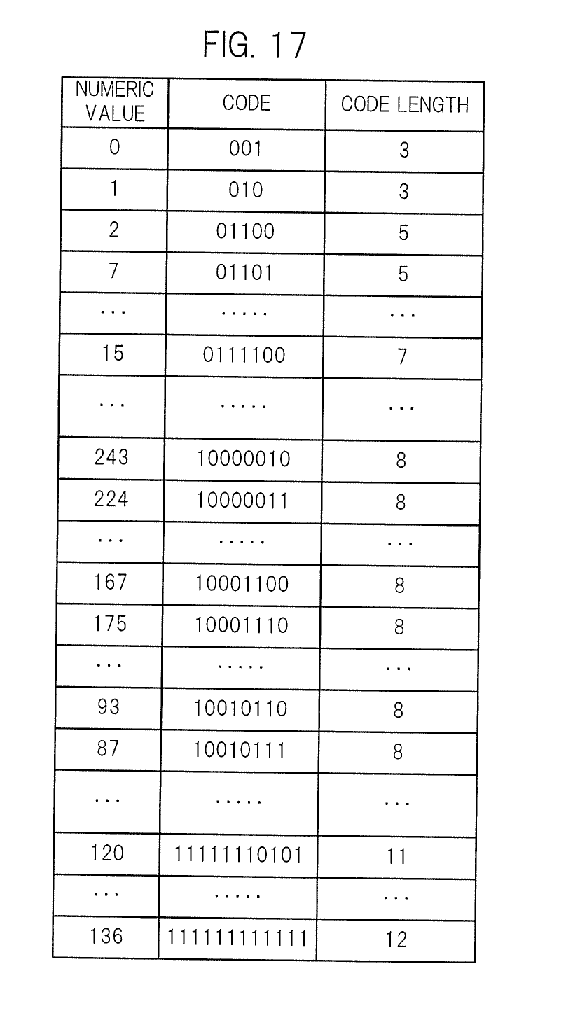

FIG. 17 is a diagram that illustrates an example of the Huffman table.

This Huffman table is a correspondence table indicating correspondence between a data value and a code, namely, one-to-one correspondence between numeric values before encoding (before being replaced) and the numeric values after the encoding (after being replaced), in which the numeric values are aligned such that a numeric value with higher frequency of occurrence is replaced with a code expressed in a smaller bit number. Incidentally, the example of codes illustrated in FIG. 17 is determined based on the frequencies of occurrence of actual data values, so that each code is different from that in FIG. 16.

The Huffman table illustrated in FIG. 17 indicates one-to-one correspondence between 256 pieces of 8-bit data from 0 to 255 and 256 pieces of codes (code length is 3 to 12 bits), and as a result of scanning by the data scanning section 552, the data is aligned in the order of frequencies of occurrence occurring in the data. In the Huffman table, a code length is also associated. For example, data “0” (a numeric value in 8 bits) in the first line of the Huffman table and data “1” in the second line have the highest frequency of occurrence, and they are associated with a code “001” and a code “010”, respectively, which have the code length in 3 bits that is the shortest bit code length. The data “2” in the third line has a second highest frequency of occurrence so that a code “01100” having the code length of 5 bits is associated with. In this way, in the Huffman table, data with a higher frequency is associated with a code having a shorter code length. In the last line of the Huffman table, data “136” whose frequency of occurrence is the lowest is associated with a code “111111111111” having the code length of 12 bits. The longest bit code length in the present embodiment is 12 bits.

In the Huffman encoding section 553 of the H-plane compression section 550 in FIG. 1, the numeric values of data are encoded in accordance with the above-described Huffman table, and as a result, many of the numeric values are replaced with codes in the smaller number of bits, thereby realizing data compression.

By the processing described above with reference to FIG. 13 through FIG. 17, the higher-order sub-plane 1D1H inputted into the H-plane compression section 550 in FIG. 1 is subjected to the encoding by the run-length encoding section 551 and the encoding by the Huffman encoding section 553, thereby being compressed using a high compression ratio and resulting in the higher-order compressed data D2H.

Next, the processing applied to the lower-order sub-plane D1L will be described. The lower-order sub-plane D1L obtained as a result of the division by the plane division section 530 is subjected to the Huffman encoding processing described with reference to FIG. 16 through FIG. 17 in the Huffman encoding section 541 of the L-plane compression section 540. The lower-order sub-plane D1L after the Huffman encoding is outputted from the L-plane compression section 540 as lower-order compressed data D2L. Incidentally, as described above, when the high-speed mode is designated by the user, the Huffman encoding processing by the Huffman encoding section 541 is omitted and the lower-order sub-plane D1L is outputted directly from the L-plane compression section 540.

A group made of the lower-order compressed data D2L and the higher-order compressed data D2H forms reversibly compressed data (TRUE pixel compression plane) in which TRUE pixel data is reversibly compressed.

Next, the irreversible compression processing for the FAKE pixel data will be described. The FAKE pixel data obtained by the thinning processing section 505 is inputted into the FAKE-pixel-data compression section 560, and the bit reducing section 561 in the FAKE-pixel-data compression section 560 encodes the FAKE pixel data into 4 bits or 1 bit, depending on whether or not the FAKE pixel data is of the pixel data in an edge portion. Whether the FAKE pixel data is of the pixel data in an edge portion or not is determined by the edge detection section 525 in FIG. 1, based on differential data after the offset by the offset section 520.

In the following, how the FAKE pixel data is encoded will be described.

When the pixel value of the TRUE pixel illustrated in FIG. 4 is expressed by Tn_k, the pixel value of the FAKE pixel adjacent to this TRUE pixel is expressed by Fn k+1 and thereafter, Fn+1_k, Fn+1_k+1 and so on. The pixel value of another TRUE pixel at a position over the FAKE pixel adjacent to the TRUE pixel mentioned first is expressed by Tn_k+2 and thereafter, Tn+2_k, Tn+2_k+2 and so on. In the edge detection section 2525, when a differential value obtained by the two-dimensional differential encoding processing from these four TRUE pixels' pixel values Tn_k, Tn_k+2, Tn+2_k and Tn+2_k+2 (here, this is not a differential value expressed by the numeric value from “00” to “FF” in hexadecimal notation as described above, but this is a differential value obtained by acquiring directly a difference of the pixel values and expressed in decimal notation) belongs to a domain bellow (−L) or a domain equal to or above (+L) defined by using a positive integer-value threshold parameter L set in the edge detection section 2525, the above-mentioned three FAKE pixels' pixel values Fn_k+1, Fn+1_k and Fn+1_k+1 are determined to be the pixel values at an edge portion and each encoded into a 4-bit code starting from “1” by the reducing section 2561.

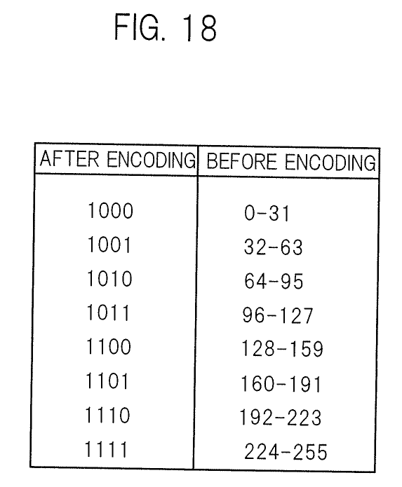

FIG. 18 is a diagram that illustrates an encoding scheme of encoding into a 4-bit code.

In this encoding scheme, the pixel value of the FAKE pixel is encoded into a code of “1000”-“1111” by cutting off lower-order five digits of an 8-bit value that represents the pixel value and adding “1” to the head of the remaining higher-order three digits. Thus, as illustrated in the list of this figure, among the numeric values “0”-“255” before the encoding, the numeric values “0”-“31” are encoded into “1000”, and the numeric values “22”-“63” are encoded into “1001”. Similarly, the numeric values “64”-“95”, “96”-“127”, “128”-“159”, “160”-“191”, “192”-“223” and “224”-“255” are encoded into “1010”, “1011”, “1100”, “1101”, “1110” and “1111”, respectively. Such an encoding method is realized by an extremely simple process in digits of a bit value are cut off. By such encoding into the 4-bit code, the information on the original image is maintained to some extent, which avoids deterioration of the image quality.

In the edge detection section 525, when the differential value obtained from the above-mentioned four TRUE pixels' pixel values Tn_k, Tn_k+2, Tn+2_k and Tn+2_k+2 by the two-dimensional differential encoding processing belongs to a domain of not less than (−L) and not more than (+L), the above-mentioned three FAKE pixels' pixel values Fn_k+1, Fn+1_k and Fn+1_k+1 are determined not to be the pixel values at an edge portion and encoded into a 1-bit code “0” in the bit reducing section 561.

The data replaced with the 1-bit or 4-bit code is subjected to the processing that is exactly the same as the above-described processing in the H-plane compression section 550 by the run-length encoding section 562, the Huffman encoding section 563 and the data scanning section 564. The FAKE pixel data after being subjected to the run-length encoding processing and the Huffman encoding processing is outputted from the FAKE-pixel-data compression section 560 as the irreversibly compressed data D3 (FAKE pixel compression plane).

A group of the lower-order compressed data D2L outputted from the L-plane compression section 540 and the higher-order compressed data D2H outputted from the H-plane compression section 550 and further the irreversibly compressed data D3 forms compressed data in which the irreversible compression processing is applied to the original image data D0 (one frame). Further, by a series of compressed data in which the irreversible compression processing is applied (compressed data of frames), compressed moving picture data in which the irreversible compression processing is applied to the original moving picture is formed.

Here, a structure of data included in one flame, before and after compression will be explained.

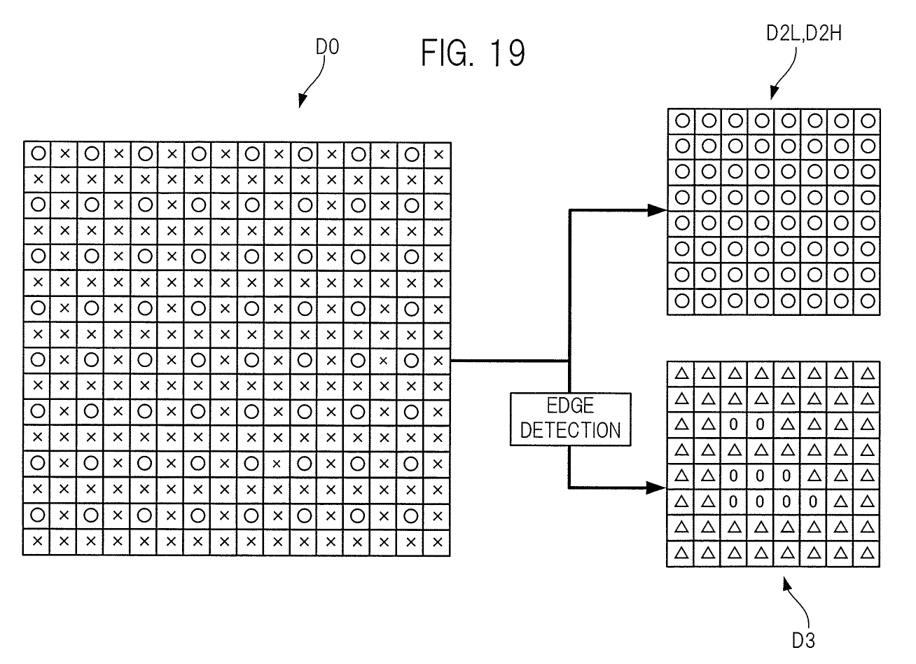

FIG. 19 is a diagram illustrating structures of data included in one flame, before and after the compression.

The frame represented by the original image data D0 before the compression has a structure in which the TRUE pixels indicated by a circle (◯) in the diagram and the FAKE pixels indicated by a cross (×) in the diagram are periodically aligned. The group of the lower-order compressed data D2L and the higher-order compressed data D2H represents the TRUE pixel compression plane in which a plane formed of the TRUE pixels are reversibly compressed. On the other hand, the irreversibly compressed data D3 represents the FAKE pixel compression plane in which a plane formed of the FAKE pixels is irreversibly compressed, and after three FAKE pixels indicated by the crosses (×) in the original image data D0 are subjected to the edge detection with these three FAKE pixels as a unit, in the irreversibly compressed data D3, they are expressed either as a pixel value indicated by one triangle (Δ) or the code “0”.

The TRUE pixel compression plane and the FAKE pixel compression plane are transmitted by the data transmission section 570.

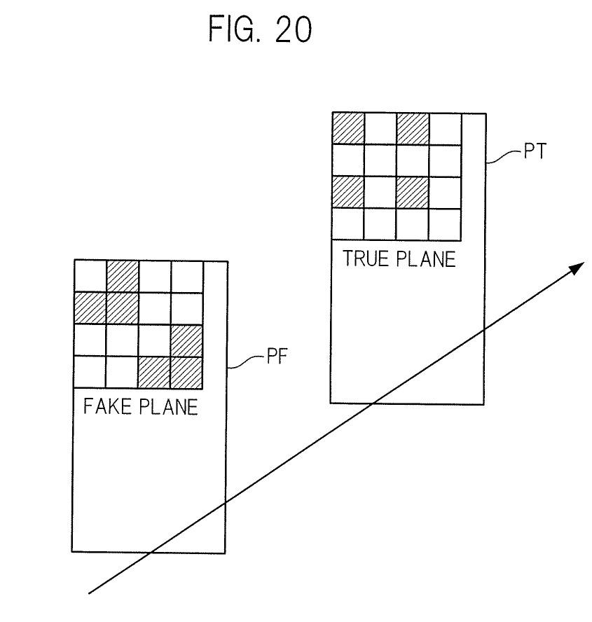

FIG. 20 is a diagram illustrating the concept of the plane transmitted by the data transmission section 570.

The data transmission section 570 transmits, for each frame, a TRUE pixel compression plane PT and a FAKE pixel compression plane PF in this order.

As described above, in the destination of the transmission, the compressed data is subjected to data decompression processing and utilized for displaying a moving picture and the like. Here, in such a case where a data loss occurs in the course of transmission, so long as the loss occurs in a part of the FAKE pixel compression plane PF, the loss is limited to information of the FAKE pixel and information of the TRUE pixel is completely restored by the TRUE pixel compression plane PT. Further, even if the information of the FAKE pixel is lost, by reproducing a frame while handling all FAKE pixels as being in a non-edge portion, the frame may be reproduced with a certain level of image quality.

In this way, by alternately transmitting the TRUE pixel compression plane PT and the FAKE pixel compression plane PF, the reproduction of each frame is tolerant of data loss. Incidentally, if only a partial loss due to a temporary transfer failure is considered, an order of transmitting the TRUE pixel compression plane PT and the FAKE pixel compression plane PF is not so important. However, if a transmission interruption of data is also taken into consideration, it is preferable to transmit in the order of the TRUE pixel compression plane PT followed by the FAKE pixel compression plane PF.

Incidentally, in the above-described embodiment, as a preferable example of the thinning processing section of the present invention, a type of thinning processing section that changes positions where pixels are taken out among the frames that are adjacent to each other with respect to time is described. However, the thinning processing section of the present invention may be a type in which a position to thin out a pixel is fixed.

What is claimed is:

1. A moving picture compression transmission apparatus comprising:
a thinning processing section that thins out numeric values from a series of numeric values of each image data forming to-be-compressed data representing a moving picture in a series of image data expressing a still image in a series of numeric values, so as to create, for each image data, first data made of a series of thinned-out numeric values and second data made of a series of remaining numeric values;
a first compression section that applies reversible compression processing to the first data;
a second compression section that applies irreversible compression processing to the second data; and
a data transmission section that transmits first compressed data obtained by the first compression section and second compressed data obtained by the second compression section, for each image data forming the to-be-compressed data.

2. The moving picture compression transmission apparatus according to claim 1, wherein, when the thinning processing section thins out numeric values, the thinning processing section changes positions of the numeric values to be thinned out on the still image, for pieces of the image data which are next to each other with respect to time.

3. The moving picture compression transmission apparatus according to claim 1, wherein the first compression section comprises a difference generation section which obtains differences between numeric values being next to each other for a series of numeric values included in the first data, so as to generate differential data made of a series of numeric values representing the differences, and the first compression section applies the reversible compression processing to the differential data generated by the difference generation section.

4. The moving picture compression transmission apparatus according to claim 1, wherein the first compression section comprises a difference generation section which obtains two-dimensional differences based on multiple numeric values adjacent to a numeric value in multiple directions on the still image, for the numeric value included in the first data, so as to generate differential data made of a series of numeric values representing the differences, and the first compression section applies the reversible compression processing to the differential data generated by the difference generation section.

5. The moving picture compression transmission apparatus according to claim 3, wherein the difference generation section generates, as the differential data, differential data made of a series of numeric values representing the differences in a predetermined unit bit number, and
the first compression section comprises:
an offset section which offsets, by a predetermined value, each numeric value included in the differential data generated by the difference generation section;
a division section which divides each numeric value of the data which are offset by the offset section into a higher-order bit portion and a lower-order bit portion at a predetermined division bit number that is smaller than the unit bit number, so as to divide the data into higher-order data including a series of the higher-order bit portions of each numeric value and lower-order data including a series of the lower-order bit portions of each numeric value; and
a higher-order data compression section which applies the reversible compression processing to the higher-order data divided by the division section.

6. The moving picture compression transmission apparatus according to claim 5, further comprising a lower-order data compression section which applies the reversible compression processing to the lower-order data divided by the division section.

7. The moving picture compression transmission apparatus according to claim 1, wherein the image data included in the to-be-compressed data is made of a series of numeric values represented in a predetermined unit bit number, and
the second compression section comprises:
a determination section which determines an edge portion in the still image; and
a data conversion section which, for the numeric values included in the second data generated by the thinning processing section, outputs a predetermined code in a bit number smaller than the unit bit number when a numeric value of the numeric values is not in the edge portion determined by the determination section, and outputs a numeric value represented in a bit number smaller than or equal to the unit bit number when the numeric value is in the edge portion.

8. The moving picture compression transmission apparatus according to claim 7, wherein the data conversion section truncates a lower-order digit of a bit value of the unit bit number for expressing a numeric value in a smaller bit number.

9. A computer-readable storage medium storing a moving picture compression transmission program which is incorporated in an information processing apparatus and executed in the information processing apparatus, thereby constructing on the information processing apparatus:
a thinning processing section that thins out numeric values from a series of numeric values of each image data forming to-be-compressed data representing a moving picture in a series of image data expressing a still image in a series of numeric values, so as to create, for each image data, first data made of a series of thinned-out numeric values and second data made of a series of remaining numeric values;
a first compression section that applies reversible compression processing to the first data;
a second compression section that applies irreversible compression processing to the second data; and
a data transmission section that transmits first compressed data obtained by the first compression section and second compressed data obtained by the second compression section, for each image data forming the to-be-compressed data.

10. A moving picture compression transmission method which is executed in an apparatus, comprising:
thinning processing of thinning out numeric values from a series of numeric values of each image data forming to-be-compressed data representing a moving picture in a series of image data expressing a still image in a series of numeric values, so as to create, for each image data, first data made of a series of thinned-out numeric values and second data made of a series of remaining numeric values;
first compression of applying reversible compression processing to the first data;
second compression of applying irreversible compression processing to the second data; and
data transmission of transmitting first compressed data obtained by the first compression and second compressed data obtained by the second compression, for each image data forming the to-be-compressed data in the order of the first compressed data followed by the second compressed data.
